(19) United States
(12) Patent Application Publication
(10) Pub. No.: US 2013/0089739 A1
(43) Pub. Date: Apr. 11, 2013

(54) NANOSTRUCTURED METAL OXIDES AND MIXED METAL OXIDES, METHODS OF MAKING THESE NANOPARTICLES, AND METHODS OF THEIR USE

(71) Applicant: King Abdullah University of Science and Technolo, Thuwal (SA)

(72) Inventors: Vivek Polshettiwar, Thuwal (SA); Aziz Fihri, Thuwal (SA)

(73) Assignee: King Abdullah University of Science and Technology (KAUST), Thuwal (SA)

(21) Appl. No.: 13/632,225

(22) Filed: Oct. 1, 2012

Related U.S. Application Data
(60) Provisional application No. 61/627,219, filed on Oct. 7, 2011.

(51) Int. Cl. C01G 53/04; B01J 19/12; C07F 15/04; C01G 49/02; B82Y 40/00; B82Y 30/00

(52) U.S. Cl. 428/402; 423/594.19; 423/594.3; 556/138; 423/594.1; 204/157.43; 977/773; 977/896

(57) ABSTRACT

Embodiments of the present disclosure provide for nanoparticles, methods of making nanoparticles, methods of using the nanoparticles, and the like. Nanoparticles of the present disclosure can have a variety of morphologies, which may lead to their use in a variety of technologies and processes. Nanoparticles of the present may be used in sensors, optics, mechanics, circuits, and the like. In addition, nanoparticles of the present disclosure may be used in catalytic reactions, for CO oxidation, as super-capacitors, in hydrogen storage, and the like.

### CROSS-REFERENCE TO RELATED APPLICATION

This application claims priority to copending U.S. Provisional application entitled “NANOSTRUCTURED METAL OXIDES AND MIXED METAL OXIDES, METHODS OF MAKING THESE NANOPARTICLES, AND METHODS OF THEIR USE” having Ser. No. 61/627,219, filed on Oct. 7, 2011, which is incorporated herein by reference.

### BACKGROUND

Fractal nano-structures are widespread in nature across all areas, from the shapes of coastlines, to the distribution of galaxies, to the shapes of clouds and even self-assembled metals and metal oxides. In case of nickel oxides also, the advance of solution-based chemical synthesis of nanostructured materials produced variety of dendritic unprecedented structures such as nanoclusters, nanowires, nanobelts, nanotubes, nanoflowers etc. which are not only useful for designing novel devices on the nano-scales but also these unique shapes and morphologies has profound effect in various catalytic reactions.

### SUMMARY

Embodiments of the present disclosure provide for nanoparticles, methods of making nanoparticles, methods of using the nanoparticles, and the like.

An embodiment of the method of making a nanoparticle, among others, includes: adding a metal compound reagent to water to form a solution; exposing the solution to a microwave energy; and forming nanoparticles including the metal of the metal compound. In an embodiment, the method also includes removing a precipitate from the solution and heating the precipitate to about 200 to 600° C. for about 1 to 3 hours to form nanoparticles.

An embodiment of the structure, among others, includes: a nanoparticle made of a material selected from: cobalt oxide, copper oxide, iron oxide, nickel oxide, cadmium oxide, indium oxide, zinc oxide, manganese oxide, titania, cobalt-copper oxide, cobalt-iron oxide, cobalt-nickel oxide, cobalt-manganese oxide, cobalt-zinc oxide, cobalt-indium oxide, cobalt-cadmium oxide, copper-iron oxide, copper-nickel oxide, copper-manganese oxide, copper-zinc oxide, copper-indium oxide, copper-cadmium oxide, iron-nickel oxide, iron-manganese oxide, iron-zinc oxide, iron-indium oxide, iron-cadmium oxide, nickel-manganese oxide, nickel-zinc oxide, nickel-indium oxide, nickel-cadmium oxide, and manganese-zinc oxide.

In an embodiment, the nanoparticle can be made of nickel oxide and has a morphology like a desert rose and has a BET measured surface area of about 27 m²g⁻¹.

In an embodiment, the nanoparticle can be made of cobalt oxide and has a morphology like a flower of spherical nanorods and has a BET measured surface area of about 44 m²g⁻¹.

In an embodiment, the nanoparticle can be made of copper oxide and has a morphology like a flower of rectangular nanorods and has a BET measured surface area of about 6 m²g⁻¹.

In an embodiment, the nanoparticle can be made of iron oxide and has a morphology like a flower of fibrous nanosheets and has a BET measured surface area of about 16 m²g⁻¹.

In an embodiment, the nanoparticle can be made of zinc oxide and has a morphology like a flower of fibrous nanosheets and has a BET measured surface area of about 41 m²g⁻¹.

In an embodiment, the nanoparticle can be made of indium oxide and has a morphology like a rectangular structure and has a BET measured surface area of about 47 m²g⁻¹.

In an embodiment, the nanoparticle can be made of manganese oxide and has a morphology like a cube and has a BET measured surface area of about 60 m²g⁻¹.

In an embodiment, the nanoparticle can be made of nickel-cobalt oxide and has a BET measured surface area of about 37 m²g⁻¹.

In an embodiment, the nanoparticle can be made of nickel-copper oxide has a BET measured surface area of about 62 m²g⁻¹.

In an embodiment, the nanoparticle can be made of nickel-iron oxide and has a BET measured surface area of about 56 m²g⁻¹.

In an embodiment, the nanoparticle can be made of nickel-manganese oxide and has a BET measured surface area of about 28 m²g⁻¹.

In an embodiment, the nanoparticle can be made of nickel-zinc oxide and has a BET measured surface area of about 86 m²g⁻¹.

An embodiment of the method of delivering a catalyst to a composition, among others, includes: contacting a composition with a nanoparticle as described herein.

An embodiment of the method for producing a nanoparticle, among others, includes: a) preparing a composition comprising a metal compound reagent, a template molecule, and a solvent, wherein the template molecule is a compound of formula:

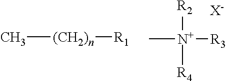

wherein n is 5 to 25, and R₁ is

or

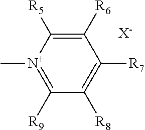

, wherein X⁻ is Cl, Br, I, or F; and R₂ through R₉ are each independently selected from the group consisting of H, Cl, Br, I, OH, and C₁-C₁₀ alkyl; b) exposing the composition of a) to heat or a microwave irradiation, wherein an oxide-containing particle is formed in the composition; and c) removing some or all of the solvent from the composition of b) to produce isolated oxide-template particles; and d) calcinating or refluxing the isolated oxide-template particles of c) to produce oxide nanoparticles.

An embodiment of the method of catalyzing a reaction in a reaction mixture, among others, includes: contacting a reaction mixture with a nanoparticle as described herein.

An embodiment of the kit, among others, includes nanoparticles as described herein in one or more sealed containers.

An embodiment of the method for storage of energy, among others, includes contacting a nanoparticle as set forth herein with a source of energy.

An embodiment of the catalyst material, among others, includes nanoparticles as set forth herein.

An embodiment of the method of making a nanoparticle, among others, includes: adding a metal compound reagent to water to form a solution; heating the solution; and forming nanoparticles including the metal of the metal compound.

Other chemicals, composition, systems, methods, features, and advantages of the present disclosure will be or become apparent to one with skill in the art upon examination of the following detailed description. It is intended that all such additional devices, systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

The patent or application file contains at least one drawing executed in color. Copies of this patent or patent application publication with color drawing(s) will be provided by the Office upon request and payment of the necessary fee.

FIGS. 1.1a-1.1d illustrate SEM images of nickel oxide nano-roses.

FIGS. 1.2a-1.2d illustrate HRTEM images of nickel oxide particles.

FIGS. 1.3a-1.3c illustrate SEM images of nickel oxide particles obtained a) without template (CTAB); b) without urea; c) in pure water.

FIG. 1.4 illustrates four different views 3D reconstruction of nickel oxide nano-roses.

FIGS. 1.5a-1.5d illustrates nickel oxide nano-roses (a) virtual cross section along xy, xz and yz axes, (a) through frontal xy axis, (c) through horizontal xz axis, (d) through sagittal yz axis.

FIGS. 1.6a and 1.6b illustrate XRD patterns of (a) nickel hydroxide, (b) nickel oxide particles.

FIGS. 1.7a-1.7d illustrate XPS spectra (a) Ni 2p of Ni(OH)₂, (b) Ni 2p of NiO, (c) O 1s of Ni(OH)₂, and (d) O 1s of NiO.

FIG. 1.8 illustrates TGA curves of nickel hydroxide particles.

FIGS. 1.9a and 1.9b illustrates N₂ sorption isotherms of (a) nickel hydroxide and (b) nickel oxide particles.

FIG. 1.10a-1.10l illustrate: (a) SEM, (b) EDX mapping of nickel-cobalt oxide; (c) SEM, (d) EDX mapping of nickel-copper oxide; (e) SEM, (f) EDX mapping of nickel-iron oxide; (g) SEM, (h) EDX mapping of nickel-manganese oxide; (i) SEM, (j) EDX mapping of nickel-zinc oxide; (k) SEM, (l) EDX mapping of nickel-indium oxide.

FIG. 1.11 illustrates a graph of a conversion vs. temperature for CO oxidation catalyzed by nickel oxide and its mixed oxides.

FIG. 1.12 illustrates a graph of CV loops of the symmetric supercapacitors based on NiO after calcination (AC) and Ni(OH)₂ before calcination (BC).

FIGS. 1.13a-1.13d illustrate: a) SEM image and (b) XRD; (c) EDX mapping and (d) N₂ sorption isotherms of nickel-zinc oxide.

FIGS. 1.14a-1.14d illustrate: (a) SEM image and (b) XRD; (c) EDX mapping and (d) N₂ sorption isotherms of nickel-manganese oxide.

FIGS. 1.15a-1.15d illustrate: (a) SEM image and (b) XRD; (c) EDX mapping and (d) N₂ sorption isotherms of nickel-iron oxide.

FIGS. 1.16a-1.16d illustrate: (a) SEM image and (b) XRD; (c) EDX mapping and (d) N₂ sorption isotherms of nickel-copper oxide.

FIGS. 1.17a-1.17d illustrate: (a) SEM image and (b) XRD; (c) EDX mapping and (d) N₂ sorption isotherms of nickel-cobalt oxide.

FIG. 1.18 illustrates a table showing the BET surface area of mixed oxides of nickel by N₂ sorption.

FIG. 1.19 illustrates three graphs that illustrate Ni 2p, Cu 2p, and O 1s high resolution spectra of NiₓCu_{y}O_{z} powder before and after calcination.

FIG. 1.20 illustrates three graphs that illustrate Ni 2p, Co 2p and O 1s high resolution spectra of NiₓCo_{y}O_{z} powder before and after calcination.

FIG. 1.21 illustrates three graphs that illustrate Ni 2p, Fe 3p and O 1s high resolution spectra of NiₓFe_{y}O_{z} powder before and after calcination.

FIG. 1.22 illustrates three graphs that illustrate Ni 2p, Mn 3p and O 1s high resolution spectra of NiₓMn_{y}O_{z} powder before and after calcination.

FIG. 1.23 illustrates three graphs that illustrate Ni 2p, Zn 2p and O 1s high resolution spectra of NiₓFe_{y}O_{z} powder before and after calcination.

FIG. 1.24 illustrates three graphs that illustrate Ni 2p, In 3d and O 1s high resolution spectra of NiₓIn_{y}O_{z} powder before and after calcination.

FIG. 2.1 illustrates SEM studies showing the formation of spherical nano-rods of cobalt oxide.

FIG. 2.2 illustrates a mass spectrum of cobalt oxide.

FIG. 2.3 illustrates SEM studies showing the formation of copper oxide.

FIG. 2.4 illustrates a mass spectrum of copper oxide.

FIG. 2.5 illustrates SEM studies showing the formation of iron oxide.

FIG. 2.6 illustrates a mass spectrum of iron oxide.

FIG. 2.7 illustrates SEM studies showing the formation of zinc oxide.

FIG. 2.8 illustrates a mass spectrum of zinc oxide.

FIG. 2.9 illustrates SEM studies showing the formation of indium oxide.

FIG. 2.10 illustrates a mass spectrum of indium oxide.

FIG. 2.11 illustrates SEM studies showing the formation of manganese oxide.

FIG. 2.12 illustrates a mass spectrum of manganese oxide.

FIGS. 3.1A to 3.1Q illustrate images, EDX mapping, and/or elemental for various nanoparticle oxides.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of material science, chemistry, physics, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. Further, documents or references cited in this text, in a Reference List before the claims, or in the text itself; and each of these documents or references (“herein cited references”), as well as each document or reference cited in each of the herein-cited references (including any manufacturer's specifications, instructions, etc.) are hereby expressly incorporated herein by reference.

### Discussion

Embodiments of the present disclosure provide for nanoparticles, methods of making nanoparticles, methods of using the nanoparticles, and the like. Nanoparticles of the present disclosure can have a variety of morphologies, which may lead to their use in a variety of technologies and processes. Nanoparticles of the present disclosure may be used in sensors, optics, mechanics, circuits, and the like. In addition, nanoparticles of the present disclosure may be used in catalytic reactions, for CO oxidation, as super-capacitors, in hydrogen storage, and the like. In particular, nickel oxide nanoparticles can be used in CO oxidation and as super-capacitors, which is described in more detail in Example 1. In an embodiment, the nanoparticles can be tuned (e.g., control of their size and/or morphology) so that the characteristics (e.g., turnover number, selectivity, and/or stability) of the nanoparticle as a catalyst can be selected.

In an exemplary embodiment, the morphology of the nanoparticles can vary based on the chemical composition of the nanoparticle. The morphology can include shapes such as a flower-type shape, a rod, a cube, a sheet, a spherical shape having rods extending from the spherical core, a platelet, a faceted particle, and the like. The surface area of the nanoparticles can vary depending on the shape of the nanoparticle. The dimensions of the nanoparticle can vary depending on the morphology, but in general, the longest dimension is about 1 and 500 nm (in diameter or length of the longest dimension), while the other dimensions (if present) can be about 1 to 500 nm. Images of exemplary embodiments of the nanoparticles are shown in Examples 1 to 3.

In an embodiment, the nanoparticle can include: cobalt oxide, copper oxide, iron oxide, nickel oxide, cadmium oxide, indium oxide, zinc oxide, manganese oxide, titania, cobalt-copper oxide, cobalt-iron oxide, cobalt-nickel oxide, cobalt-manganese oxide, cobalt-zinc oxide, cobalt-indium oxide, cobalt-cadmium oxide, copper-iron oxide, copper-nickel oxide, copper-manganese oxide, copper-zinc oxide, copper-indium oxide, copper-cadmium oxide, iron-nickel oxide, iron-manganese oxide, iron-zinc oxide, iron-indium oxide, iron-cadmium oxide, nickel-manganese oxide, nickel-zinc oxide, nickel-indium oxide, nickel-cadmium oxide, and manganese-zinc oxide. As mentioned above, the morphology and the dimensions can vary depending on the different types of nanoparticles. Examples 1 to 3 describe various embodiments of the nanoparticles.

In an embodiment, the nanoparticle is made of nickel oxide. The nickel oxide nanoparticle can have a morphology similar to a desert rose (on the nanoscale) and can have a BET measured surface area of about 27 m²g⁻¹. Additional details are provided in Example 1.

In an embodiment, the nanoparticle is made of cobalt oxide. The cobalt oxide nanoparticle can have a morphology similar to a flower of spherical nanorods and can have a BET measured surface area of about 44 m²g⁻¹.

In an embodiment, the nanoparticle is made of copper oxide. The copper oxide nanoparticle can have a morphology similar to a flower of rectangular nanorods and can have a BET measured surface area of about 6 m²g⁻¹.

In an embodiment, the nanoparticle is made of iron oxide. The iron oxide nanoparticle can have a morphology similar to a flower of fibrous nanosheets and can have a BET measured surface area of about 16 m²g⁻¹.

In an embodiment, the nanoparticle is made of zinc oxide. The zinc oxide nanoparticle can have a morphology similar to a flower of fibrous nanosheets and can have a BET measured surface area of about 41 m²g⁻¹.

In an embodiment, the nanoparticle is made of indium oxide. The indium oxide nanoparticle can have a morphology similar to a rectangular structure and can have a BET measured surface area of about 47 m²g⁻¹.

In an embodiment, the nanoparticle is made of manganese oxide. The manganese oxide nanoparticle can have a morphology similar to a cube and can have a BET measured surface area of about 60 m²g⁻¹.

In an embodiment, the nanoparticle is made of nickel-cobalt oxide. The nickel-cobalt oxide nanoparticle can have a BET measured surface area of about 37 m²g⁻¹.

In an embodiment, the nanoparticle is made of nickel-copper oxide. The nickel-copper oxide nanoparticle can have a BET measured surface area of about 62 m²g⁻¹.

In an embodiment, the nanoparticle is made of nickel-iron oxide. The nickel-iron oxide nanoparticle can have a BET measured surface area of about 56 m²g⁻¹.

In an embodiment, the nanoparticle is made of nickel-manganese oxide. The nickel-manganese oxide nanoparticle can have a BET measured surface area of about 28 m²g⁻¹.

In an embodiment, the nanoparticle is made of nickel-zinc oxide. The nickel-zinc oxide nanoparticle can have a BET measured surface area of about 86 m²g⁻¹.

In an embodiment, the nanoparticle can have attached to it one or more ligands. In an embodiment, each ligand can be independently selected from: a metal catalytic molecule, a drug, and an organic molecule. The ligand can be attached to the nanoparticle via a linker, can be absorbed onto the nanoparticle, or can be adsorbed onto the nanoparticle, where different ligands can be attached differently. The number of ligands attached to the nanoparticle can be about 1 to 100,000, or more.

In an embodiment, the linker can be a group such as: an alkyl, a hydride, a carbene, a carbyne, a cyclopentadienyl, an alkoxide, an amido, or an imido, or a compound including one or more of these groups.

As used herein, “alkyl” or “alkyl group” refers to a saturated aliphatic hydrocarbon radical which may be straight or branched, having 1 to 20 carbon atoms, wherein the stated range of carbon atoms includes each intervening integer individually, as well as sub-ranges. Examples of alkyl groups include, but are not limited to, methyl, ethyl, i-propyl, n-propyl, n-butyl, t-butyl, pentyl, hexyl, septyl, octyl, nonyl, decyl, and the like.

In an embodiment, the ligand is a metal catalytic molecule. The metal catalytic molecule can be a metal ion or a metal oxide. In an embodiment, the metal catalytic molecule can include a metal selected from: Au, Pt, Pd, Ag, Ni, Ru, Rh, Ir, Os, Co, Fe, and Cu. In an embodiment, the metal catalytic molecule can include a metal oxide selected from: Al₂O₃, TiO₂, Fe₂O₃, CeO₂, CuO, ZnO, SiO₂, V₂O₅, MgO, La₂O₃, ZrO₂, SnO₂, MnO₂, MoO₃, Mo₂O₅, and a zeolite.

An embodiment of the present disclosure can include delivering a catalyst to a composition as well as a catalyst. The method can include contacting a composition with a catalyst such as a nanoparticle as described herein. The catalyst can include one or more types of nanoparticles described herein.

An embodiment of the present disclosure can include catalyzing a reaction in a reaction mixture. The method can include contacting a reaction mixture with a nanoparticle as described herein.

An embodiment of the present disclosure can include a kit comprising one or more types of nanoparticle, as described herein, in one or more sealed containers. In addition, a set of directions for use of the nanoparticle can be included with one or more of the containers, where the uses can include any of those described herein as well as directions for attaching one or more ligands to the nanoparticle.

An embodiment of the present disclosure can include a method for storage of energy. The method can include contacting a nanoparticle, as described herein, with a source of energy. In an embodiment, the source of energy can include electricity, heat, or gas.

Another embodiment of the present disclosure includes a method of making a nanoparticle such as those described herein. In an embodiment, the method includes: a) preparing a composition comprising a metal compound reagent, (optionally) a template molecule, and a solvent (e.g., cyclohexane, pentanol, and water); b) exposing the composition of a) to heat or microwave irradiation, wherein an oxide-containing particle is formed in the composition; c) removing some or all of the solvent from the composition of b) to produce isolated oxide-template particles; and d) calcinating or refluxing (e.g., with an alcohol such as ethanol) the isolated oxide-template particles of c) to produce oxide nanoparticles. In an embodiment, the composition can include urea.

In an embodiment, the composition of a) can be exposed to heat and not microwave irradiation. In an embodiment, the composition of a) is exposed to microwave irradiation and not heat.

In an embodiment, the nanoparticle can be attached to a ligand, such as those described herein.

Another embodiment of the present disclosure includes a method of making a nanoparticle such as those described herein. In one embodiment the method includes the use of microwave energy, and in another embodiment, the method includes the use of a furnace or other thermal reactor to heat the solution described below.

In an embodiment, the method includes adding a metal compound reagent to water to form a solution. In an embodiment, the solution does not contain any organic solvent unless otherwise noted herein. The metal compound reagent can include a metal salt such as a metal halogen compound (e.g., nickel chloride, iron chloride, copper chloride, cadmium chloride, cobalt chloride, indium chloride, manganese chloride, zinc chloride, titanium chloride, and the like), or a combination thereof. In an embodiment, the concentration of the metal compound reagent in the solution can be about 1 mmole to 10 mole. In an embodiment, the solution is at a temperature of about 80 to 200° C., about 100 to 140° C. or about 120° C. The solution can be mixed using conventional mixing techniques.

In an embodiment, the solution includes a template compound. The template compound functions as a structure directing agent or coating agent. In an embodiment, the template compound can be a compound defined by the formula:

CH₃—(CH₂)ₙR₁

wherein n is 5 to 25, and R₁ is

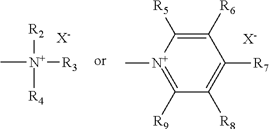

, wherein X⁻ is Cl, Br, I, or F; and R₂ through R₉ are each independently selected from: H, Cl, Br, I, OH, and C₁-C₁₀ alkyl. In an embodiment, the solution includes a template compound such as: cetyltrimethylammonium bromide, cetylpyridinium bromide, similar molecules, and a combination thereof. In an embodiment, the ratio of the metal compound reagent to the template compound is about 0 to 10 or 1 to 10.

Subsequently, the solution is exposed to a microwave energy. The microwave energy can originate from a microwave reactor and can have an energy of about 0.1 to 800 W or about 800 W. Example 1 describes an exemplary embodiment of a microwave reactor. In an embodiment, the solution can be exposed to the microwave energy for about 2 minutes to 6 hours, about 2 to 6 hours, or about 4 hours. In an embodiment, the microwave energy can be constant or can vary (e.g., cycling) over the time frame of exposure.

Once the exposure to the microwave energy is complete, a precipitate can be removed from the solution. In an embodiment, the precipitate can be heated to about 200 to 600° C. or about 350 to 450° C. for about 1 to 3 hours to form nanoparticles. The nanoparticles include the metal of the metal compound reagent. In an embodiment, the nanoparticles can include metal oxides or metal-metal oxides such as those described herein.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLES

### Example 1

### Brief Introduction

Nano-scale nickel oxides and their mixed oxides were fabricated under microwave irradiation conditions in pure water. The nickel oxides self-assembled into desert roses like unique nanostructure. These desert nano-roses of nickel oxides were then studied using electron tomography by virtual cross section through the particle to understand its morphology from inside-out. These materials were then evaluated successfully as nano-catalysts for CO oxidation and as super capacitors.

### Introduction

Fractal nano-structures are widespread in nature across all areas, from the shapes of coastlines, to the distribution of galaxies, to the shapes of clouds¹ and even self-assembled metals²⁻⁴ and metal oxides.⁵ In case of nickel oxides also, the advance of solution-based chemical synthesis of nanostructured materials produced variety of dendritic unprecedented structures⁶⁻¹⁷ such as nanoclusters, nanowires, nanobelts, nanotubes, nanoflowers etc. which are not only useful for designing novel devices on the nano-scales but also these unique shapes and morphologies has profound effect in various catalytic reactions.^{5,18} However, it is exigent to develop easy and sustainable approaches for building hierarchically self-assembled fractal architectures of these materials. Microwave (MW) chemistry has been widely used in synthetic organic chemistry, with enhanced reaction rates, selectivity and product yields.¹⁹⁻²⁰ Although, this technique is also useful for the synthesis of high quality nanomaterials via direct MW heating of their molecular precursors,²¹ the hierarchical self-assembly nickel oxides under MW irradiation has been rarely researched.

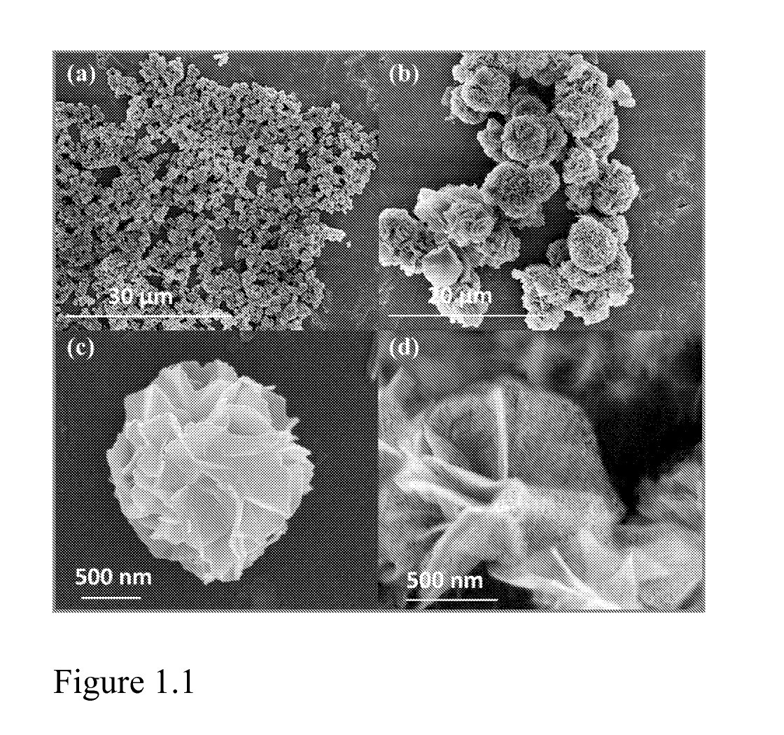

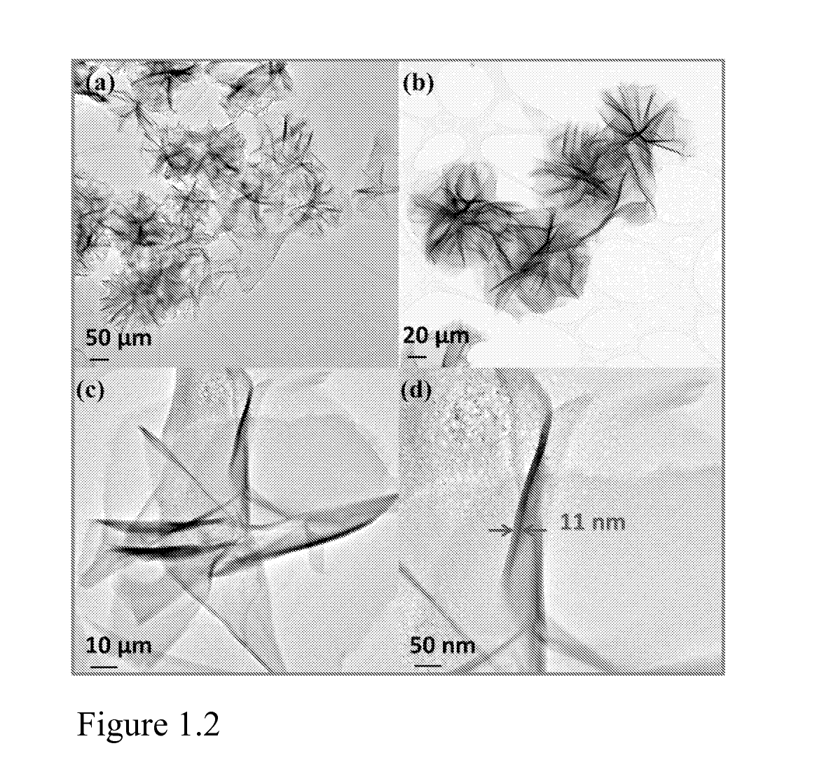

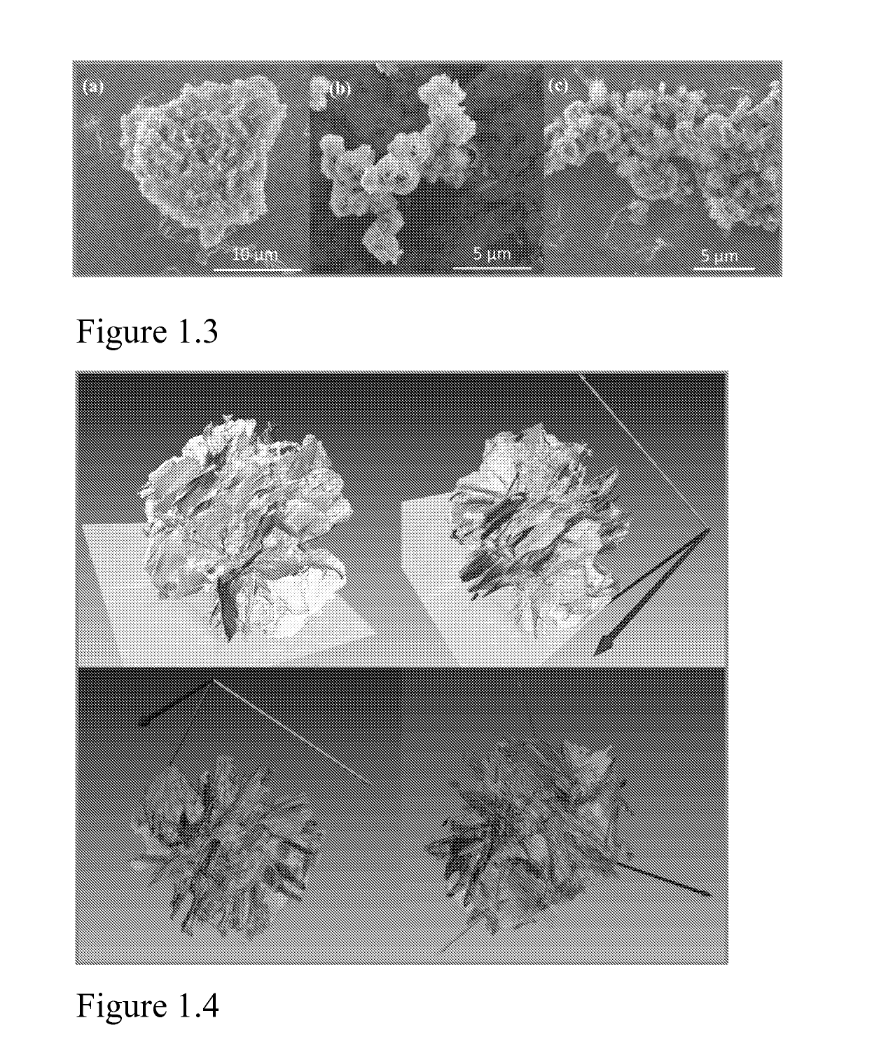

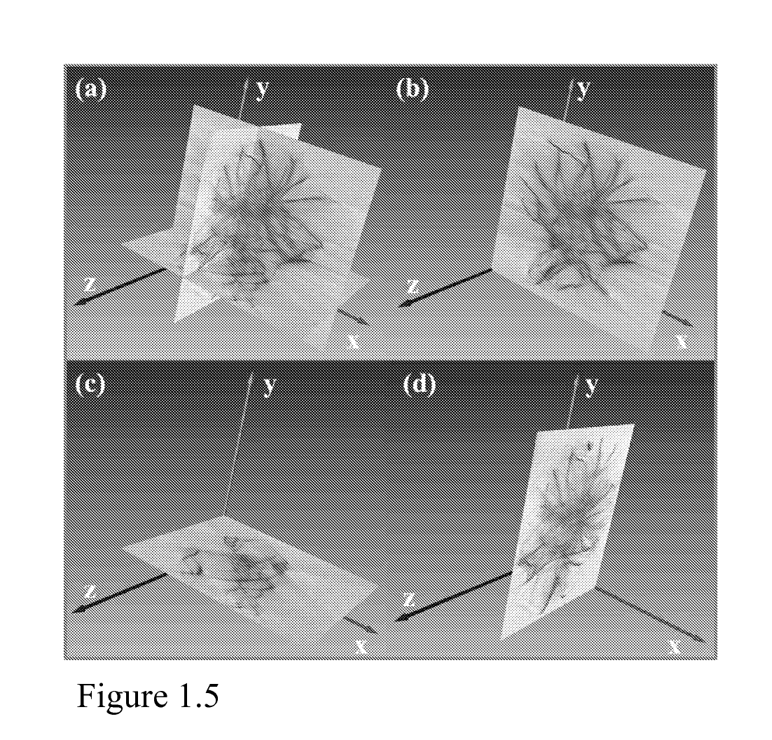

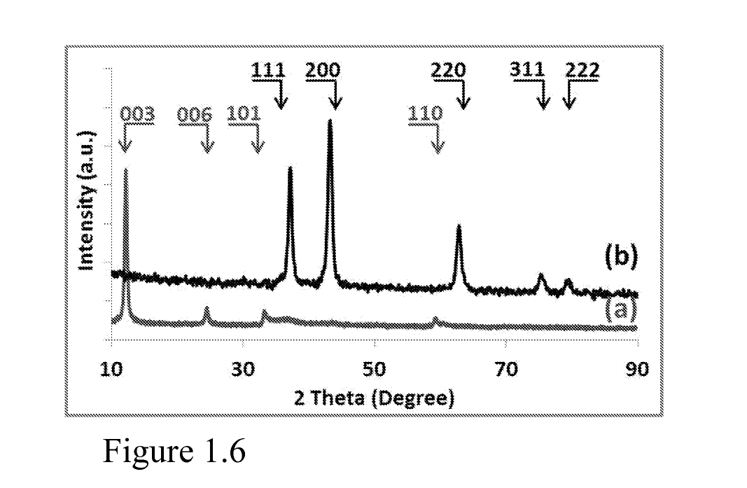

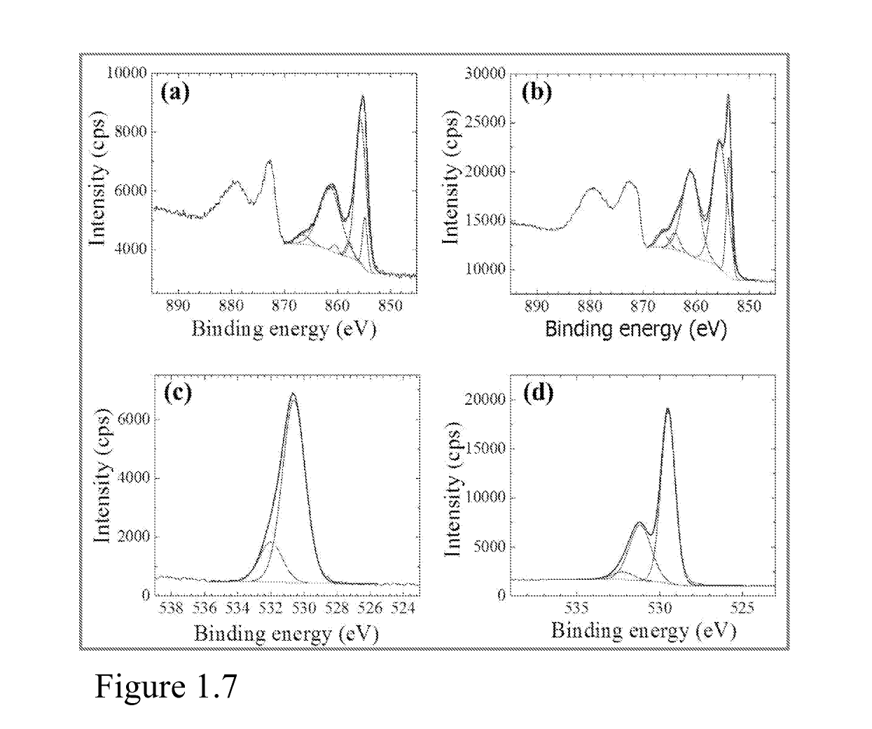

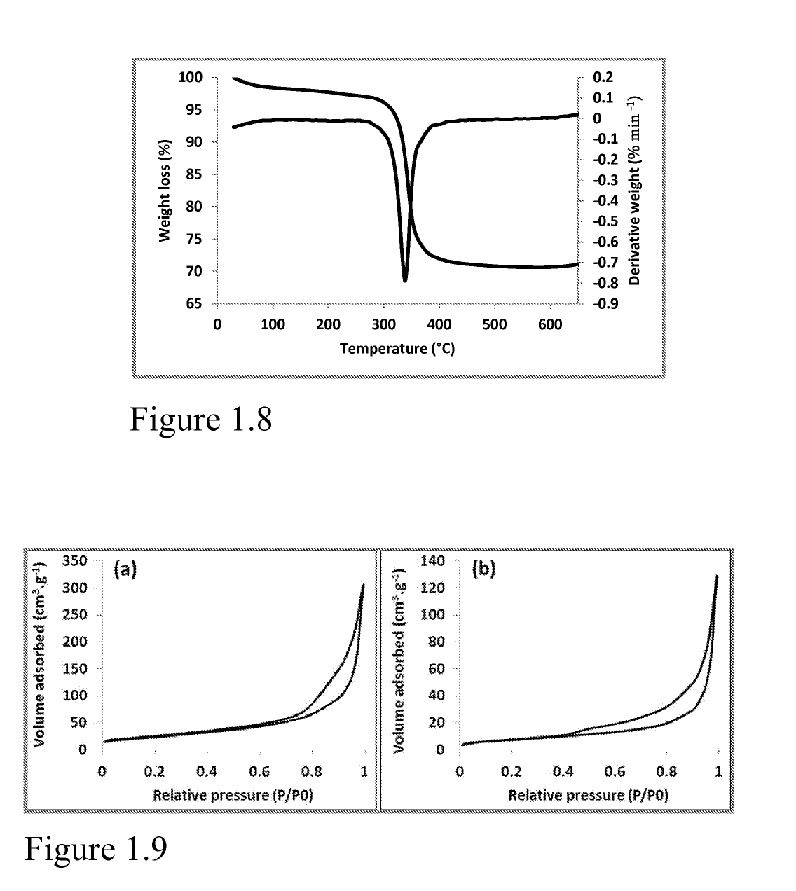

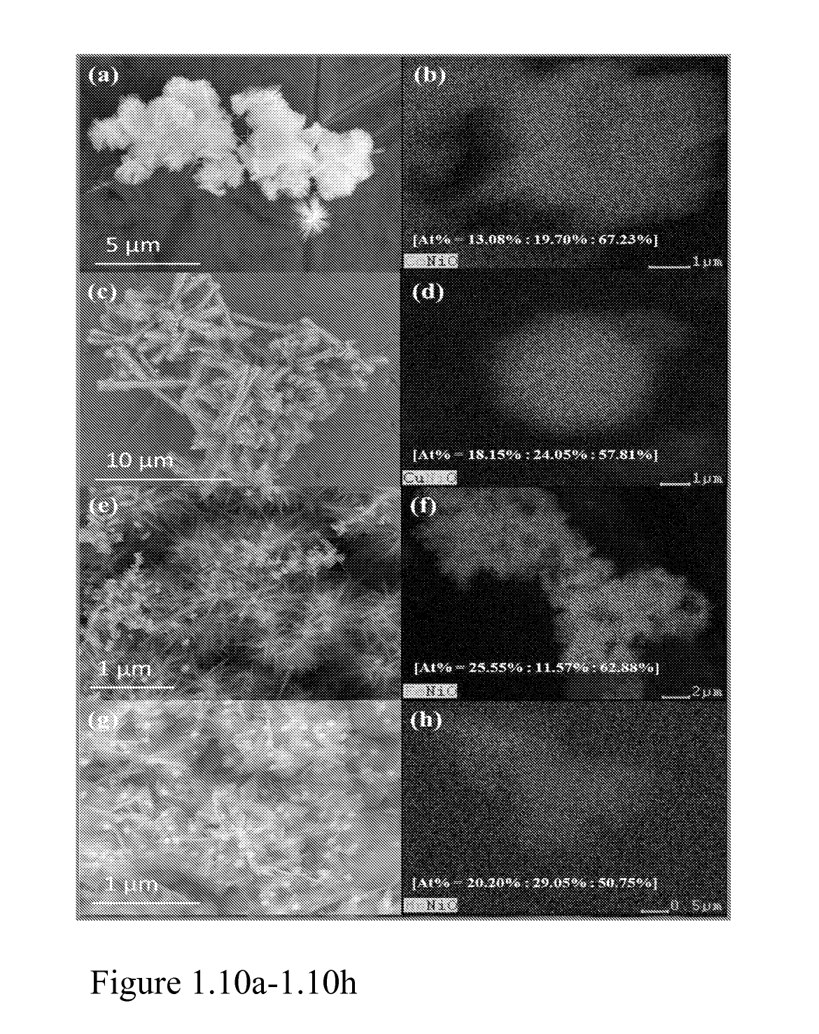

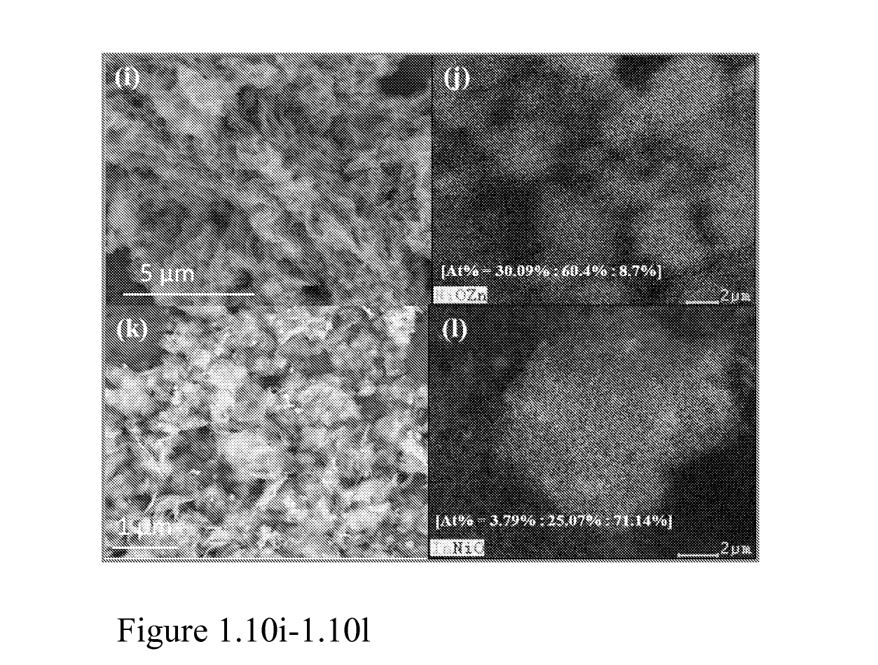

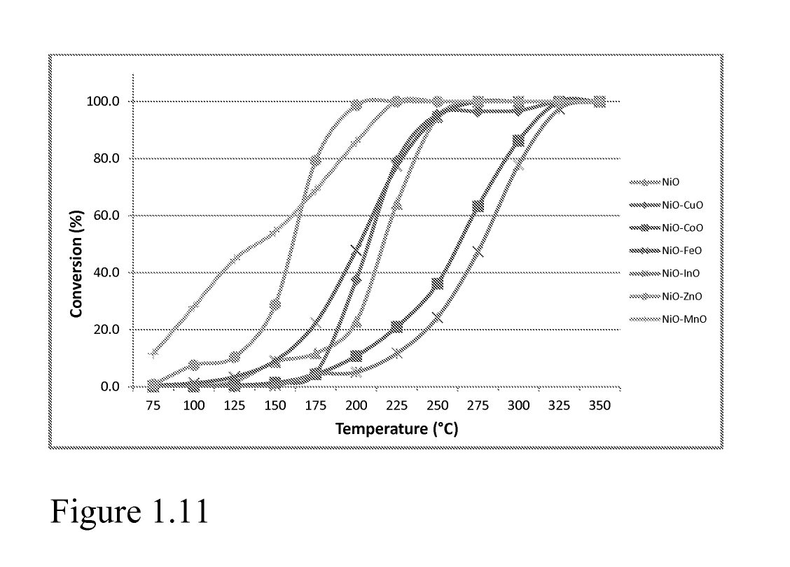

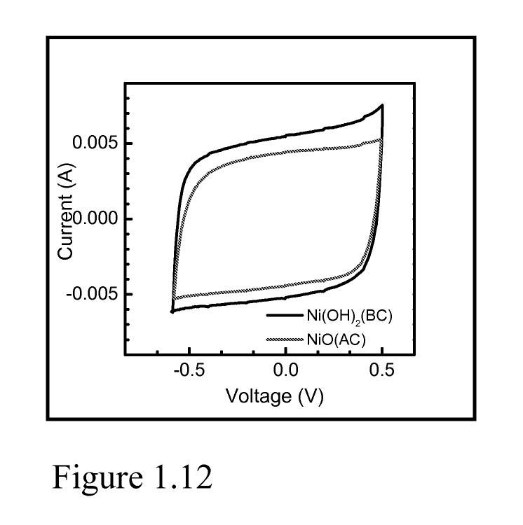

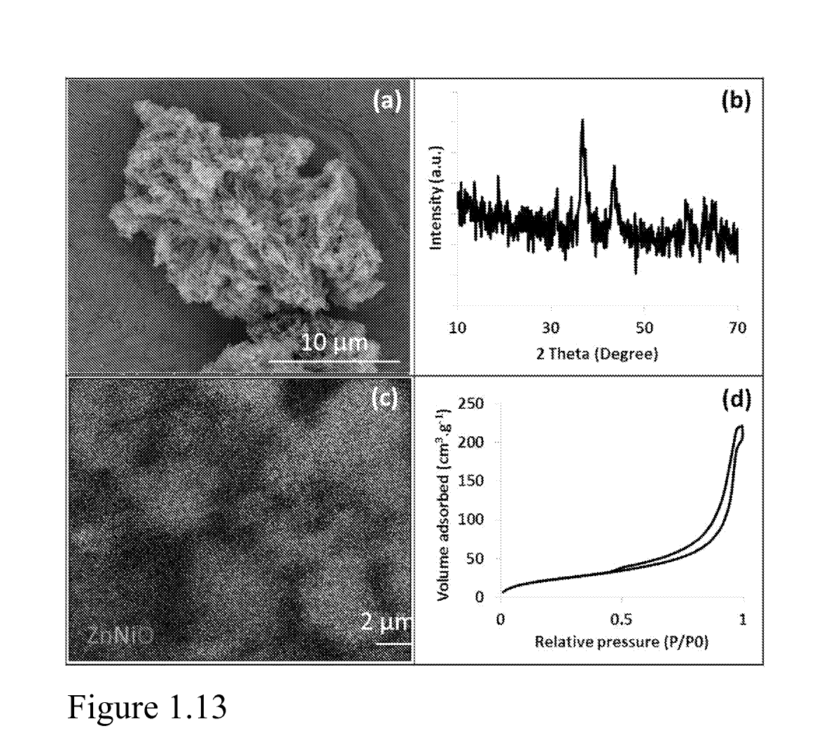

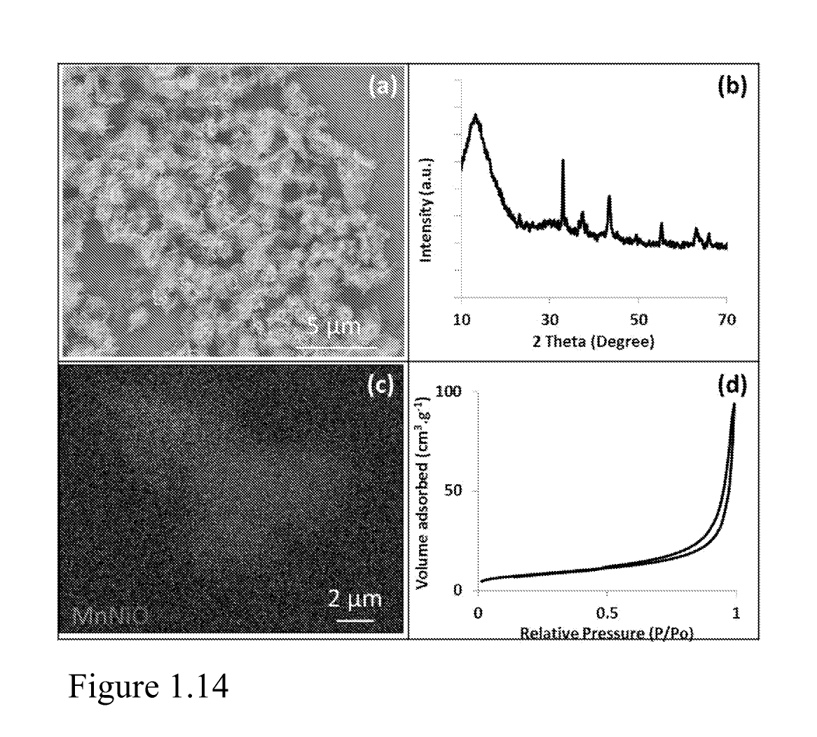

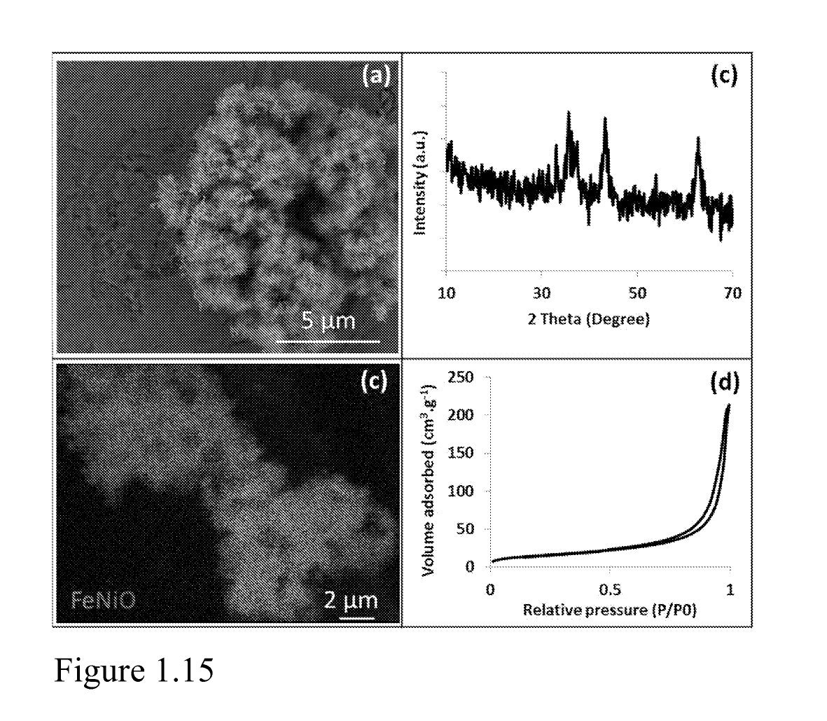

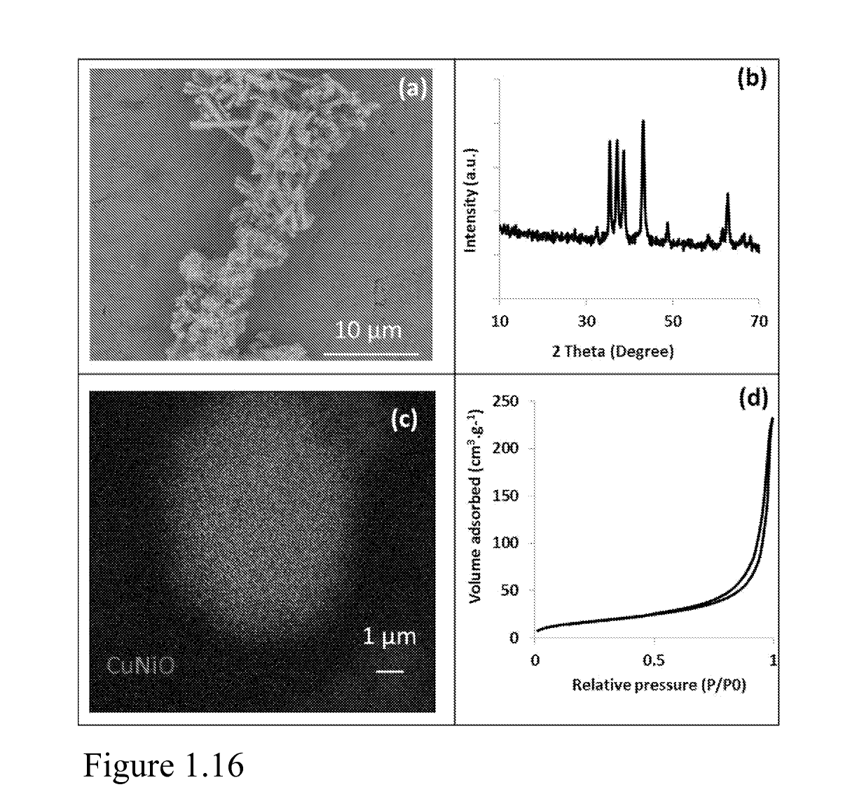

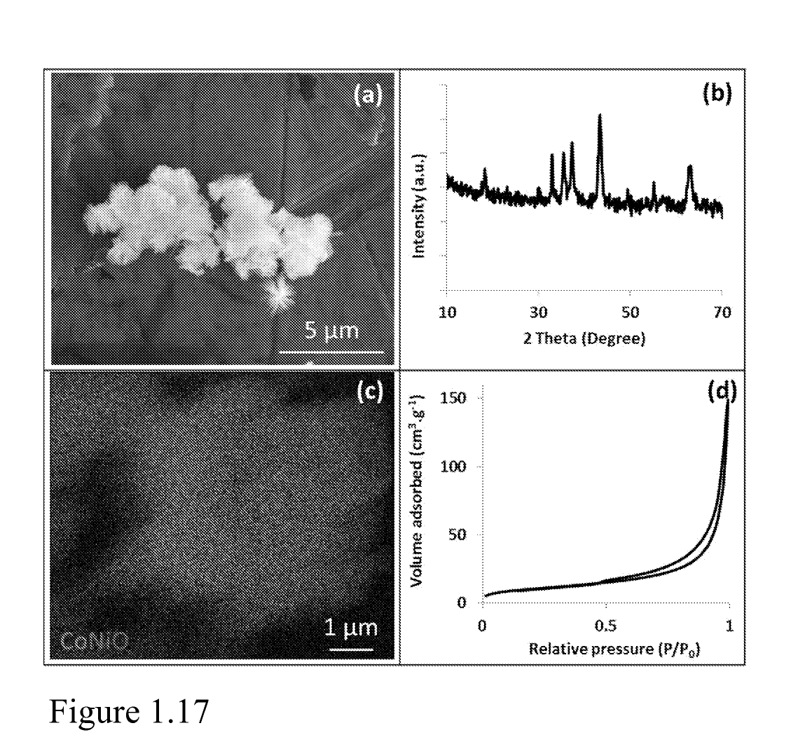

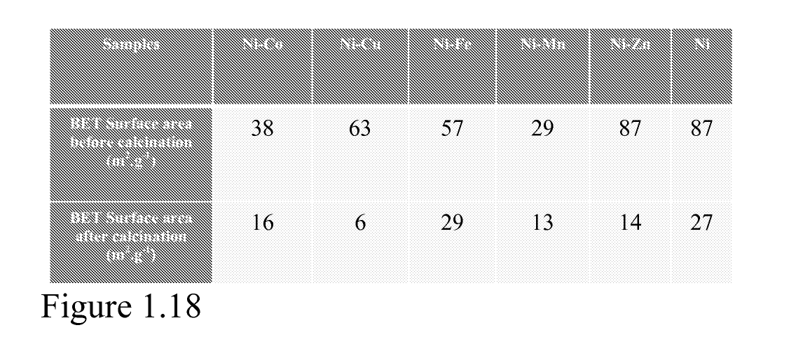

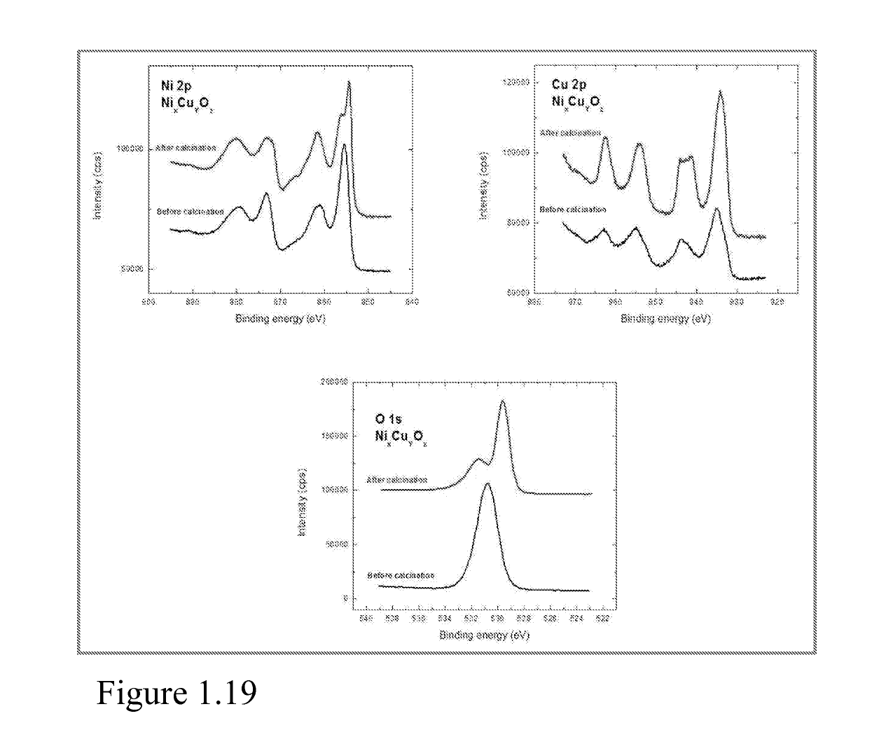

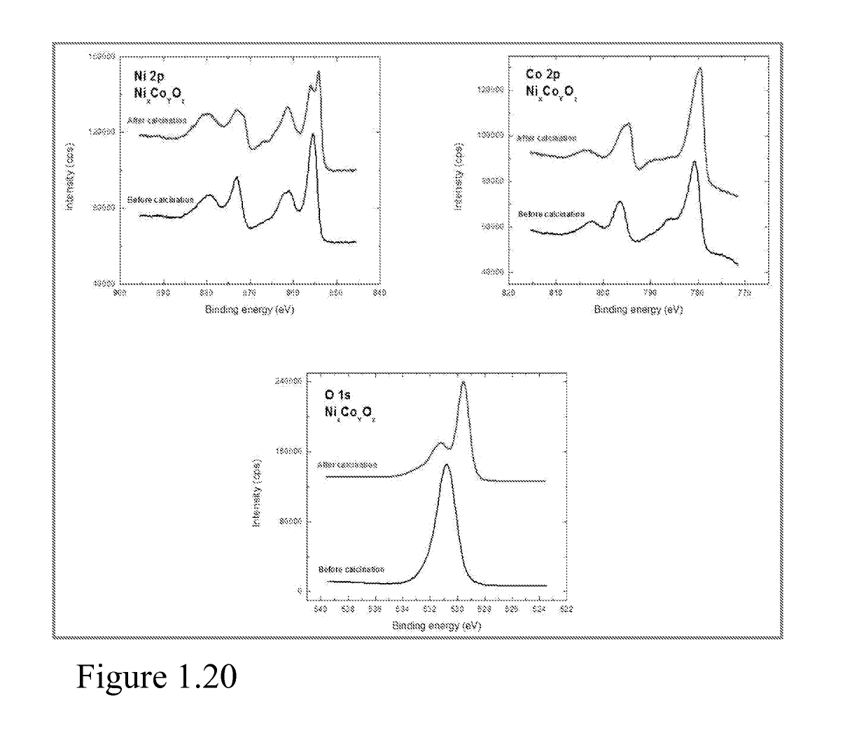

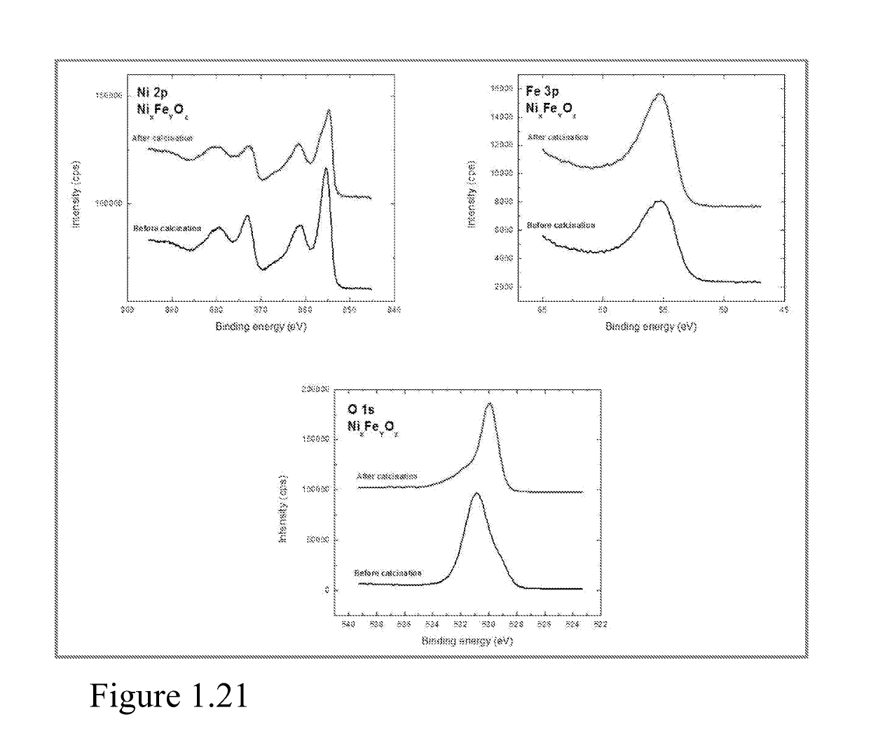

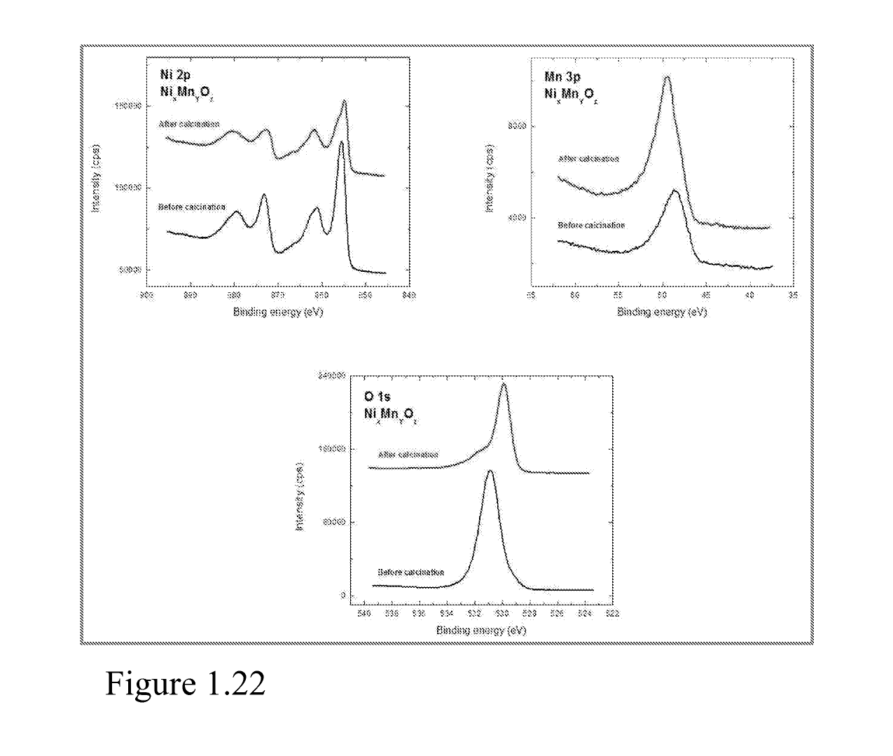

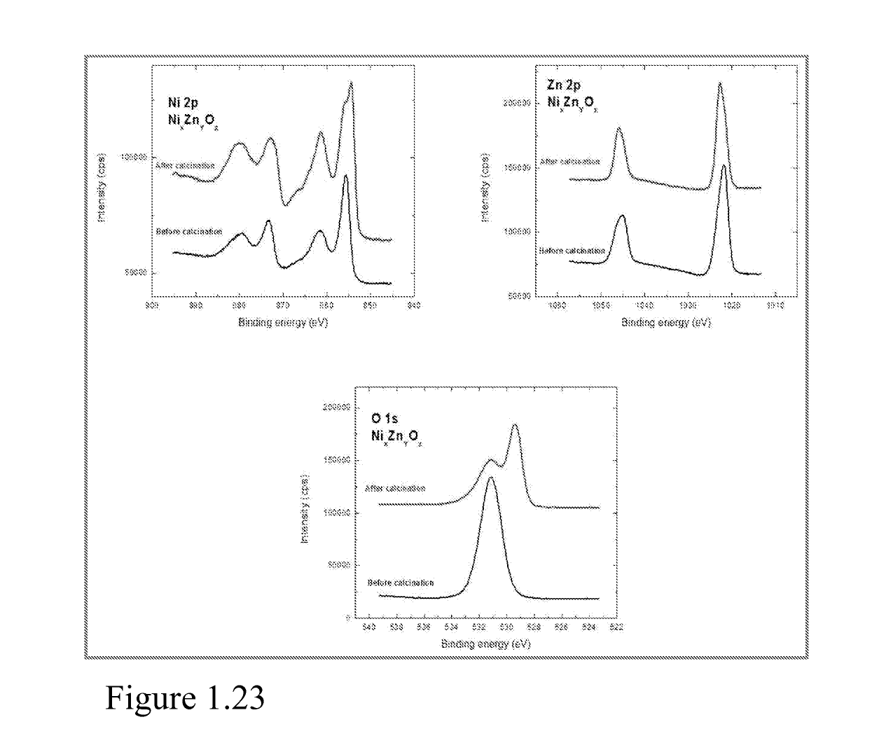

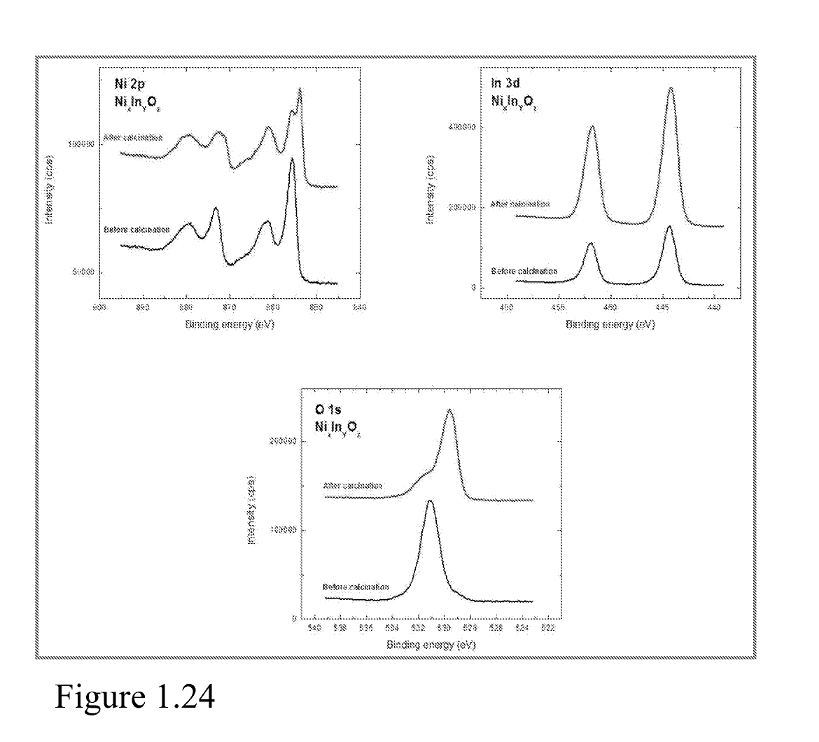

After our initial success for the hierarchical self-assembly of nanomaterials under green and sustainable conditions²²⁻²⁴ and recent discovery of high surface nano-silica (KCC-1) with fibrous morphology,²⁵⁻²⁶ here we report a facile synthesis of nickel oxide with unique desert rose-nanostructure (FIGS. 1.1 & 1.2). These nickel oxide nanomaterial was synthesized by green aqueous microwave assisted technique²⁷ using cetyltrimethylammonium bromide (CTAB) as structure directing template, in pure water without using any organic solvent.

FIG. 1.1 shows typical scanning electron microscopy (SEM) images of as-synthesized nickel oxides it indicate that the material are rose like hierarchical structure with diameters that range from 800 nm to 1000 nm. Close inspection of these images reveals that the material possesses lightly packed irregular sheets (like petals of a flower which were assembled together to form rose like flower shape) interweave together forming an open porous structure. It was observed from SEM image of calcined material (FIG. 1.1d) that these sheets remain assembled together even after heating at 400° C. indicating that they are strongly connected with each other (although merging of these nano-flowers was observed) and flower like morphology of the materials was preserved. Interestingly, we observed formation of pores in petals of a nickel oxide nano-roses, when heated at 600° C. These pores can be smartly used to decorate these petals with nanoscale metals, to design metal oxide/metal bi-functional catalysts.

Further structural characterization of synthesized material performed by high-resolution transmission electron microscopy (HRTEM) (FIG. 1.2) reveals that these nanopetals are curved shape with thickness in the range 10-15 nm. It can also be seen that these petals has pale and homogeneous contrast, confirming their skinny thickness.

Although first we obtained this material using the reactions conditions that of KCC-1 synthesis, i.e. hydrothermal treatment of metal salt in a cyclohexane:pentanol:water mixture using urea as hydrolyzing agent. FIG. 1.3 illustrates SEM images of nickel oxide particles obtained a) without a template (CTAB); b) without urea; and c) in pure water. However, after optimization of reaction conditions by changing different synthesis parameters, we observed that the morphology of the material strongly depends on the structure directing template, CTAB, and to obtain a desert rose type architecture of nickel oxide (FIG. 1.3a). However, cyclohexane, 1-pentanol and urea had no effect of morphology (FIG. 1.3b and 1.3c) and those nano-roses of nickel oxide were obtained in pure water.

Although SEM and HRTEM imaging of nickel oxides indicates the flowery nature of the material, it was not clear whether there is solid cores inside or not. The three-dimensional (3D) electron tomography study of nickel oxides was then conducted. The four different views of a 3D reconstruction of the corresponding particle are shown (FIG. 1.4) and single nickel oxide nanoparticle appears as a “flowery cluster of sheets”. 3D re-construction of entire nickel oxide nano-roses indicates uniform density inside and outside the nano-roses structure and rule out presence of any core in its center.

The virtual cross section of the single nanoparticle of nickel oxide through frontal, sagittal and horizontal directions (FIG. 1.5) suggest that the obtained nanostructures (desert roses) are not aggregates of many individual sheets, but a single crystal, with nano-sheets (like petals of a flower) were assembled together to form rose like flower shape. FIG. 1.5 illustrates nickel oxide nano-roses (a) virtual cross section along xy, xz and yz axes, (a) through frontal xy axis, (c) through horizontal xz axis, (d) through sagittal yz axis.

FIG. 1.6 shows the XRD pattern of the as-synthesized as well the calcined at 400° C. for 3 h material. All the diffraction peaks of FIG. 1.6a could be indexed as a rhombohedral α-Ni(OH)₂ structures (JCPDS card 38-0715, a=3.08 A°). After calcination, these peaks disappeared indicating the complete conversion of hydroxide and hence the formation of pure cubic NiO phase (FIG. 1.6b) and the diffraction peaks are in good agreement with the data of JCPDS card number of 47-1049, a=4.17710 A°. The average crystalline size estimated by Sherrer's equation was 9.3 nm, calculated from the most intense (200) diffraction peak.

Surface compositions and chemical states of this material (before and after calcination) were studied by X-ray photoelectron spectroscopy (XPS). FIG. 1.7 illustrates XPS spectra of (a) Ni 2p of Ni(OH)₂, (b) Ni 2p of NiO, (c) O 1s of Ni(OH)₂, (d) O 1s of NiO. FIGS. 1.7a and 1.7c shows nickel (Ni) 2p high resolution spectra of the nickel hydroxide and nickel oxide. A Shirley background is applied across the Ni 2p3/2 portion of the spectra. The spectrum of Ni 2p3/2 nickel hydroxide is well fitted with that of standard α-Ni(OH)₂ sample whereas the Ni 2p3/2 in nickel oxide is well fitted with the NiO standard sample.²⁸ Although both standard NiO and Ni(OH)₂ powders contain divalent nickel (Ni²⁺) species, the shape of the main lines are distinctly different, which is well known.^{28,29} The peak positions, FWHM, and area percentages of each component are presented in Table 1 of the supporting information. The oxygen (O) 1s high resolution spectra for the nickel hydroxide and nickel oxide are shown in FIGS. 1.7c and 1.7d. The nickel hydroxide contains two O species at 530.6 eV and 532.0 eV. The major O species at 530.6 eV is assigned to a hydroxide bound to Ni(OH).^{28,30} The peak at 532.0 eV is attributed to adsorbed hydrocarbons and/or adsorbed water.^{28,31} The O 1s high resolution spectra of nickel oxide contains three major O species at 529.5 eV, 531.2, and 532.2 eV. The first peak is assigned to O bonded within a regular oxide crystal (O2-), and the second is assigned to oxygen atoms in positions adjacent to Ni vacancies (O (def)) within the oxide structure and the third small peak is assigned to adsorbed hydrocarbons.²⁸⁻³²

The thermogravimetric analysis (TGA) results (FIG. 1.8 illustrates TGA curves of nickel hydroxide particles) show total weight loss of 30%, which was due to the decomposition of α-Ni(OH)₂. Since this step was completed before 400° C., this temperature was chosen for calcination to obtain NiO.

The surface area and textural properties of these materials was also examined by nitrogen sorption analysis using BET technique. The surface area of β-Ni(OH)₂ and NiO was found to be 87 m²g⁻¹ and 27 m²g⁻¹ respectively, with both showing type IV isotherms (FIG. 1.9). FIG. 1.9 illustrates N₂ sorption isotherms of (a) nickel hydroxide, (b) nickel oxide particles.

### Plausible Mechanism for the Formation of Nanostructured Materials:

The exact mechanism for the formation of nickel oxides with a desert rose shape and morphology is complex to understand and yet unresolved at this stage. However, we believe that nucleation and crystal growth are two factors for the formation of these nanostructured nickel oxides.³³⁻³⁷ In the case of dendritic nanostructures, the resulting morphology of material is the conciliation between the inherent crystal structure of the material and the kinetic factors (such as rate of hydrolysis of metal chloride to from hydroxide) during the synthesis process. The preferred growth on certain planes of metal oxides becomes energetically favorable when the surface tensions of these planes are high and the bulk energy of the total system tends to decline.³³⁻³⁷ To permit anisotropic growth, the surface tensions of these planes can be tuned by manipulating various experimental conditions, like the precursor substrate, its concentration, use of different hydrolyzing agents, reaction temperature, and time. Crystalline phases of the seeds and subsequent growth can also influence the morphology of these nano-oxides, as they can have a range of different crystallographic phases and the stable phase is highly dependent on the reaction conditions and environment. In our system, because of the use of no reducing agent or base, it slows down the rapid formation of the metal hydroxide. Also, the use of ionic template (cetyltrimethylammonium bromide) can reduce the formation rate of free metal ions in the solution. At low concentration of free metal ions, the supersaturation is low, therefore, ions can combine to form nuclei and then slowly grow in the later stage to form nickel oxide of desert rose shapes.

### Mixed Metal Oxides:

In addition to nano-scale nickel oxides, much interest has focused on the use of nickel based mixed oxides, for various applications including catalysis.^{38,39} In order to show the generality of our MW-assisted synthesis protocol, we synthesized various mixed metal oxides of nickel, using exactly the same reactions conditions. Notably, we were able to synthesize a range of mixed oxides with very unique morphologies as shown in FIG. 1.10. (XPS and BET results are given in supporting information). FIG. 1.10 illustrates (a) SEM, (b) EDX mapping of nickel-cobalt oxide; (c) SEM, (d) EDX mapping of nickel-copper oxide; (e) SEM, (f) EDX mapping of nickel-iron oxide; (g) SEM, (h) EDX mapping of nickel-manganese oxide; (i) SEM, (j) EDX mapping of nickel-zinc oxide; and (k) SEM, (l) EDX mapping of nickel-indium oxide.

In order to show the utility of nickel oxide and its mixed oxides, we tested them as a catalyst for CO oxidation. The respective conversion curves for the different Ni and mixed Ni-oxides are shown in FIG. 1.11. From the figure it is clear that NiO—ZnO catalyst shows the high activity for CO oxidation and reaches 100% conversion at relatively low temperature 200° C. The NiO—InO sample has however shows negligible CO oxidation activity at low temperature and need higher temperature (325° C.) to achieve 100% conversion. It was also observed that the light-off temperature for CO oxidation (T50) of Cu, Mn, Zn and Fe doped NiO catalysts were at a much lower temperature than that of Co and In doped ones. Generally CO oxidation on transition metal oxides follows a mechanism proposed by Mars-Van Krevelen,⁴⁰ implying that the lattice oxygen incorporation occurs during CO oxidation and that the reduced surface of the metal oxide is rejuvenated by taking up oxygen from the feed mixture.⁴¹ However, recent reports clearly indicate the key role of morphology of metal oxides and their exposed planes.⁴² More in depth mechanistic studies are underway to understand these effects.

Porous structure with high surface area, large pore volume and novel morphologies combined with the well-defined electrochemical redox nature makes the nickel oxide a suitable material for supercapacitor applications.^{43,44} Therefore, the as-synthesized nickel oxides and their mixed metal oxides were also evaluated for supercapacitor properties.

The CV loops of the symmetric supercapacitors based on NiO and Ni(OH)₂ before calcination (BC) based composite electrodes measured in a potential range of −0.6 V to 0.5 V (vs. standard hydrogen electrode) at a scan rate of 20 mV/s are shown in FIG. 1.12. FIG. 1.12 illustrates CV loops of the symmetric supercapacitors based on NiO after calcination (AC) and Ni(OH)₂ before calcination (BC).

Fabricated supercapacitors exhibit rectangular CV loops, which are characteristics for capacitor behavior. The area of the CV curves decreases upon calcination which leads to a decrease in the specific capacitance and this is consistent with the fact that the surface area of NiO is found to be lower than that of Ni(OH)₂. The same trend is observed in mixed oxides of nickel as well (Table 1 of Example 1). Despite the large particle size (about 1 μm), the composites exhibited excellent supercapacitor performance comparable with NiO samples having a particle size in the range of 50-60 nm.⁴⁵ Values of capacitance are strictly connected with the nature and surface of the electrode/electrolyte interface. Porous nature of active material and mesoporous carbon increases the effective contact of the electrolyte and the electrode materials. In addition, progressive redox reactions occurring at the surface and bulk of transition metal oxides/hydroxides through Faradaic charge transfer contribute to the capacitance and the presence of mesoporous carbon helps in retaining cycling stability of the capacitors. Presence of manganese (Mn) increases the specific capacitance of NiO and Ni(OH)₂. Among the different samples investigated, Ni—Cu mixed hydroxide exhibits a maximum capacitance of 169 F/g, this result is very promising as the cost of this material is much cheaper than the conventional supercapacitor electrode materials.⁴⁶ We believe like for catalysis, morphology also playing key role in deciding supercapacitor properties and this is first observation of its kind

Table 1 of Example 1.
Supercapacitor performance of mixed nickel oxides

| Mixed | Cₛₚ (F/g) | Cₛₚ (F/g) |
|---|---|---|
| Oxides | (Before calcination) | (After calcination) |
| Ni | 128 | 102 |
| Ni—Cu | 169 | 119 |
| Ni—Co | 137 | 109 |
| Ni—Fe | 148 | 112 |
| Ni—Mn | 152 | 124 |
| Ni—Zn | 142 | 104 |

### CONCLUSIONS

We have developed a convenient synthetic protocol for nickel oxide with unique desert nano-roses morphology under MW irradiation conditions. Materials were readily prepared from inexpensive starting materials in pure water. This facile synthetic protocol could ultimately enable the designing new catalyst by tuning their shape and morphologies. The nickel oxides self-assembled into desert roses and mixed oxides of nickel into various unique shapes and morphologies. As-synthesized nickel oxide was then studied using electron tomography by virtual cross section through the particle to understand its morphology in detailed. These materials were then evaluated successfully as nano-catalysts for CO oxidation and good conversion was achieved at moderate temperatures. They were also evaluated for their supercapacitor properties and results were very promising than the conventional supercapacitor electrode materials. We believe like for catalysis, morphology also playing key role in deciding supercapacitor properties and this is first observation of its kind

### Methods

### Synthesis of Nickel Oxide.

In a typical synthesis, cetyltrimethylammonium bromide (2 mmol) and urea (8 mmol) are dissolved in 40 ml of H₂O. Following stirring for 20 mins, a stirred solution of the precursor nickel acetate (1 mmol), in 5 ml water was added. The mixture was stirred for 1 hr at room temperature. The reaction solution was then transferred to a teflon-sealed microwave reactor. The reaction mixture was exposed to a microwave irradiation (800 W maximum powers) of 120° C. for 4 hrs. After cooling the mixture at room temperature, the precipitated powders were isolated by centrifugation, washed thoroughly with distillated water, ethanol, acetone and air dried. Calcination was conducted at 400° C. for 3 h in presence of air.

### Synthesis of Mixed Oxides of Nickel.

In a typical synthesis, cetyltrimethylammonium bromide (2 mmole) and urea (8 mmole) are dissolved in 40 ml of water. Following stirring for 20 mins, a stirred solution of the precursor nickel acetate (0.5 mmol) in 5 ml of H₂O, and a solution of the precursor [0.5 mmole; cobalt chloride (CoCl₂.6H₂O); copper chloride (CuCl₂.2H₂O); iron chloride (FeCl₂.4H₂O); manganese chloride (MnCl₂.4H₂O); zinc chloride (ZnCl₂)] in 5 ml of H₂O, cyclohexane (40 ml) and 1-pentanol (2.4 ml) were added to the solution. Consequently, the mixture was stirred for 1 hr at room temperature. The reaction solution was then transferred to a Teflon-sealed microwave reactor. The reaction mixture was exposed to a microwave irradiation (800 W maximum powers) of 120° C. for 4 hrs. After cooling the mixture at room temperature, the precipitated powders were isolated by centrifugation, washed thoroughly with distillated water, ethanol, acetone and air dried.

### Electron Tomography Study.

NiO nanoparticles were suspended in ethanol, deposited on a holey carbon film precoated with 15 nm nanogold particles and dryed for 5 min before examination. Nanoparticles were imaged using a Titan CT (FEI Company, Eindhoven, the Netherlands) operating at 300 kV equipped with a 2 k×2 k CCD camera (Gatan, Pleasanton, Calif., USA). Tilt series for tomographic reconstruction were acquired using the Xplore 3D tomography software (FEI Company). The sections were rotated (typically from −65° to +65° with images being captured at 2° initial intervals following a Saxton scheme). Tomograms were generated using the IMOD software. 3D rendering models were generated with the segmentation tools implemented in Avizo.

### X-Ray Photoelectron Spectroscopic (XPS) Analysis.

XPS studies were carried out in a Kratos Axis Ultra DLD spectrometer equipped with a monochromatic Al Kα X-ray source (hν=1486.6 eV) operating at 150 W, a multi-channel plate and delay line detector under 1.0×10⁻⁹ Ton vacuum. Measurements were performed in hybrid mode using electrostatic and magnetic lenses, and the take-off angle (angle between the sample surface normal and the electron optical axis of the spectrometer) was 0°. All spectra were recorded using an aperture slot of 300 μm×700 μm. The survey and high-resolution spectra were collected at fixed analyzer pass energies of 160 and 40 eV, respectively. The instrument work function was calibrated to give an Au4f_{7/2} metallic gold binding energy of 83.95 eV. The spectrometer dispersion was adjusted to give a binding energy of 932.63 eV for metallic Cu 2p_{3/2}. Samples were mounted in floating mode in order to avoid differential charging [1,2]. Charge neutralization was required for all samples. Binding energies were referenced to the C 1s binding energy of adventitious carbon contamination which was taken to be 284.80 eV. The data were analyzed with commercially available software, CasaXPS. The individual peaks were fitted by a Gaussian(70%)-Lorentzian (30%) (GL30) function after Shirley type background subtraction.

### Experimental of CO Oxidation.

The catalytic tests for CO oxidation by O₂ were carried out in a fixed-bed continuous flow reactor. The nickel oxide or its mixed oxides (50 mg) was supported between glass wool plugs in a tubular quartz reactor of 5 mm internal diameter which was placed in an electric furnace. Temperature in the reactor was controlled by PID temperature controller connected with the thermocouple placed inside catalyst bed. The catalytic activity was determined using a feed gas composition of 2% CO and 20% O₂ in helium. All these three gases were first mixed in a mixing bulb. The individual gas flow rates were controlled using mass flow controllers, previously calibrated for each specific gas. The mixture of gases was then allowed to pass over the catalyst at a rate of 60 mL/min. The temperature of the furnace was raised slowly from room temperature to 350° C., to optimize the lowest possible temperature for 100% CO conversion. At this temperature, the activity of the catalysts was tested for CO oxidation continuously for 2 h. The feed gases and the products were analyzed employing an online Gas Chromatograph equipped with a TCD detector using helium as a carrier gas.

### Measurement of Supercapacitor Properties.

In order to prepare the supercapacitor electrodes, each one of the nickel based oxide or hydroxide was mixed with mesoporous carbon and polytetrafluoroethylene (PTFE) binder in a mass ratio of 75:20:5 using ethanol as a solvent. The resultant mixture was then coated onto the conductive carbon cloth (ELAT, Nuvant systems Inc.) of area 1.61 cm². As-prepared electrodes were dried at 100° C. for 6 h in a vacuum oven to remove the solvent. Two symmetric electrodes (each with a mass of ˜4 mg (excluding binder)), separated by a thin polymer separator (Celgard®) in 30 wt % KOH aqueous electrolyte, were sandwiched in a supercapacitor test cell (ECC-std, EL-Cell GmbH). The electrochemical properties of the supercapacitor electrodes were studied by symmetric assemblies of each material in a two electrode configuration by cyclic voltammetry (CV) galvanostatic charge-discharge and electrochemical impedance spectroscopy (EIS) using a Modulab (Solartron Analytical) electrochemical workstation. The two electrode configuration is preferred as it provides the most reliable results of a material's performance for electrochemical capacitors. From the cyclic voltammograms, the specific capacitance (Cₛₚ in F/g) was then calculated as,

$${C}_{sp} = \frac{A}{fvm}$$

Where ‘Cₛₚ’ is the specific capacitance, ‘A’ is the integral area of the CV loop, ‘f’ is the scanrate, ‘v’ is the potential window and ‘m’ is the mass of each electrode.

Additional materials are described in the following figures.

FIGS. 1.13a-1.13d illustrate: a) SEM image and (b) XRD; (c) EDX mapping and (d) N₂ sorption isotherms of nickel-zinc oxide.

FIGS. 1.14a-1.14d illustrate: (a) SEM image and (b) XRD; (c) EDX mapping and (d) N₂ sorption isotherms of nickel-manganese oxide.

FIGS. 1.15a-1.15d illustrate: (a) SEM image and (b) XRD; (c) EDX mapping and (d) N₂ sorption isotherms of nickel-iron oxide.

FIGS. 1.16a-1.16d illustrate: (a) SEM image and (b) XRD; (c) EDX mapping and (d) N₂ sorption isotherms of nickel-copper oxide.

FIGS. 1.17a-1.17d illustrate: (a) SEM image and (b) XRD; (c) EDX mapping and (d) N₂ sorption isotherms of nickel-cobalt oxide.

FIG. 1.18 illustrates a table showing the BET surface area of mixed oxides of nickel by N₂ sorption.

FIG. 1.19 illustrates three graphs that illustrate Ni 2p, Cu 2p, and O 1s high resolution spectra of NiₓCu_{y}O_{z} powder before and after calcination.

FIG. 1.20 illustrates three graphs that illustrate Ni 2p, Co 2p and O 1s high resolution spectra of NiₓCo_{y}O_{z} powder before and after calcination.

FIG. 1.21 illustrates three graphs that illustrate Ni 2p, Fe 3p and O 1s high resolution spectra of NiₓFe_{y}O_{z} powder before and after calcination.

FIG. 1.22 illustrates three graphs that illustrate Ni 2p, Mn 3p and O 1s high resolution spectra of NiₓMn_{y}O_{z} powder before and after calcination.

FIG. 1.23 illustrates three graphs that illustrate Ni 2p, Zn 2p and O 1s high resolution spectra of NiₓFe_{y}O_{z} powder before and after calcination.

FIG. 1.24 illustrates three graphs that illustrate Ni 2p, In 3d and O 1s high resolution spectra of NiₓIn_{y}O_{z} powder before and after calcination.

### REFERENCES

### Each of which is Incorporated Herein by Reference

1. Klug, A. From Macromolecules to Biological Assemblies. Angew. Chem. Int. Ed. 1983, 22, 565-582.
2. Sun, S.; Murray, C. B; Weller, D.; Folks, L.; Moser, A. Monodisperse FePt Nanoparticles and Ferromagnetic FePt Nanocrystal Superlattices. Science 2000, 287, 1979-1982.
3. Shevchenko, E. V.; Talapin, D. V.; Kotov, N. A.; O'Brien, S.; Murray, C. B. Structural Diversity in Binary Nanoparticle Superlattices. Nature 2006, 439, 55-59.
4. Moore, J. S.; Kraft, M. L. Chemistry: Synchronized Self-Assembly. Science 2008, 320, 620-621.
5. Xie, X.; Shen, W. Nanoscale, 2009, 1, 50-60.
6. Meher, S. K.; Justin, P.; Rao, G. R. ACS Appl. Mater. Interfaces 2011, 3, 2063-2073.
7. Cao, F.; Zhang, F.; Deng, R.; Hu, W.; Liu, D.; Song, S.; Zhang, H. CrystEngComm. 2011, 13, 4903-4908.
8. Shang, S.; Xue, K.; Chen, D.; Jian, X. CrystEngComm. 2011, 13, 5094-5099.
9. Laing, Z. -H.; Zhu, Y. -J.; Hu, X. -L. J. Phys. Chem. B 2004, 108, 3488-3491.
10. Yu, C.; Zhang, L.; Shi, J.; Zhao, J.; Gao, J.; Yan, D. Adv. Funct. Mater. 2008, 18, 1544-1554.
11. Chen, D.; Gao, L. Chem. Phy. Lett. 2005, 405, 159-164.
12. Song, X.; Gao, L. J. Phys. Chem. C 2008, 112, 15299-15305.
13. Pang, H.; Lu, Q.; Gao, F. Chem. Commn. 2009, 7542-7544.
14. Cui, Y.; Wang, C.; Wu, S.; Liu, G.; Zhang, F.; Wang, T. CrystEngComm. 2011, 13, 4930-4934.
15. Zhu, Z.; Wei, N.; Liu, H; He, Z. Adv. Power Tech. 2011, 22, 42-426.
16. Wang, L.; Hao, Y.; Zhao, Y.; Lai, Q.; Xu, X. J. Solid State Chem. 2010, 183, 2576-2581.
17. Liang, H.; Yang, H.; Liu, L.; Yang, Z.; Yang, Y. Superlattices & Microstuc. 2010, 48, 569-576.
18. Xie, X.; Li, Y.; Liu, Z. -Q.; Hartua M.; Shem, W. Nature, 2009, 458, 746.
19. V. Polshettiwar and R. S. Varma, Acc. Chem. Res., 2008, 41, 629.
20. V. Polshettiwar and R. S. Varma, Chem. Soc. Rev., 2008, 37, 1546.
21. V. Polshettiwar, M. N. Nadaguada and R. S. Varma, Aus. J. Chem., 2009, 62, 16.
22. V. Polshettiwar, B. Baruwati and R. S. Varma, ACS Nano, 2009, 3, 728.
23. M. N. Nadaguada, V. Polshettiwar and R. S. Varma, J. Mat. Chem., 2009, 19, 2026.
24. V. Polshettiwar, M. N. Nadaguada and R. S. Varma, Chem. Commun., 2008, 6318
25. V. Polshettiwar, D. Cha, X. Zhang and J. M. Basset, Angew. Chem. Int. Ed., 2010, 49, 9652.
26. V. Polshettiwar, J. Thivolle-Cazat, M. Taoufik, F. Stoffelbach, S, Norsic and J. M. Basset, Angew. Chem. Int. Ed., 2011, 50, 2747.
27. Aqueous Microwave Chemistry; Eds V. Polshettiwar and R. S. Varma, RSC Publishing: Cambridge, 2010.
28. M. C. Biesinger, B. P. Payne, L. W. M. Lau, A. Gerson and R. St. C. Smart. Surf Interface Anal. 41, (2009) P. 324
29. A. P. Grosvenor, M. C. Biesinger, R. St. C. Smart and N. S. McIntrye, Surf. Sci. 600 (2006), p. 1771.
30. M. C. Biesinger, B. P. Payne, A. P. Grosvenor, L. W. M. Lau, A. R. Gerson and R. St. C. Smart. Appl. Surf Sci. 257, (2011) P. 2717
31. B. P. Payne, M. C. Biesinger and N. S. McIntyre, J. Electron Spectrosc. Rel. Phenom. 175 (2009), p. 55
32. A. F. Carley, P. R. Chalker and M. W. Roberts, Proc. R. Soc. Lond. A 399 (1985), p. 167.
33. Zhang, K. Q. In Situ Observation of Colloidal Monolayer Nucleation Driven by an Alternating Electric Field. Nature 2004, 429, 739-743.
34. Kortan, A. R.; Hull, R.; Opila, R. L.; Bawendi, M. G.; Steigerwald, M. L.; Carroll, P. J.; Brus, L. E. Nucleation and Growth of Cadmium Selendie on Zinc Sulfide Quantum Crystallite Seeds, and Vice Versa, in Inverse Micelle Media. J. Am. Chem. Soc. 1990, 112, 1327-1332.
35. Milliron, D. J.; Hughes, S. M.; Cui, Y.; Manna, L.; Li, J. B.; Wang, L. W.; Alivisatos, A. P. Colloidal Nanocrystal Heterostructures with Linear and Branched Topology. Nature 2004, 430, 190-195.
36. Xu, L.; Zhang, W.; Ding, Y.; Yu, W.; Xing, J.; Li, F.; Qian, Y. Shape-Controlled Synthesis of PbS Microcrystals in Large Yields via A Solvothermal Process. J. Cryst. Growth 2004, 273, 213-219.
37. Manna, L.; Milliron, D. J.; Meisel, A.; Scher, E. C.; Alivisatos, A. P. Controlled Growth of Tetrapod-Branched Inorganic Nanocrystals. Nature Mater. 2003, 2, 382-385.
38. Frost, R. L. J. Therm. Ana. Calor. 2005, 81, 351-355.
39. Xiang, X.; Hima, H. I.; Wang, H.; Li, F. Chem. Mater. 2008, 20, 1173-1182.
40. P. Mars, D. W. Van Krevelen, Chem. Eng. Sci. Spec. (Suppl. 3) (1954) 41.
41. A. V. Salker, N. J. Choi, J. H. Kwak, B. S. Joo, D. D. Lee, Sens. Actuators B 106 (2005) 461-467.
42. Y. Teng, Y. Kusano, M. Azuma, M. Harutac and Y. Shimakawaa, Catal. Sci. Technol., 2011, 1, 920-922.
43. Srinivasan, V. and Weidner, J. W. An electrochemical route for making porous nickel oxide electrochemical capacitors. J. Electrochem. Soc., 1997, 144, L210-L213.
44. Lota, K.; Sierczynska, A.; Lota, G. Supercapacitors based on nickel oxide/carbon materials composites. International Journal of Electrochemistry 2011, Vol. 2011, Article ID 321473, 6 pages.
45. Zheng, Y-z.; Ding, H-y.; Zhang, M-l. Preparation and electrochemical properties of nickel oxide as a supercapacitor electrode material. Materials Research Bulletin 2009, 4, 403-407.
46. Simon, P.; Gogotsi, Y. Materials for electrochemical capacitors. Nature Materials 2008, 7, 845-854.

### Example 2

Fabrication of Cobalt Oxide (CO₃O₄): Self-Assembly into Flowers of Spherical Nano-Rods.

MW-assisted hydrothermal heating of cobalt chloride in water-cyclohexane mixture in presence of cetyl pyridinium bromide (CPB) and urea, yielded cobalt oxides. In a typical synthesis, cetyltrimethylammonium bromide (2 mmol) was dissolved in 40 mL of H₂O and stirred for 20 min. A stirred solution of the precursor cobalt chloride (1 mmol) in 5 mL of H₂O was then added to the first solution. The mixture was stirred for 1 h at room temperature. The reaction solution was then transferred to a Teflon-sealed microwave reactor. The reaction mixture was exposed to microwave radiation (800 W maximum power) at 120° C. for 4 h. After the mixture was cooled to room temperature, the precipitated powders were isolated by centrifugation; washed thoroughly, in sequence, with distilled water, ethanol and acetone; and air dried. Calcination was performed at 400° C. for 3 h in air.

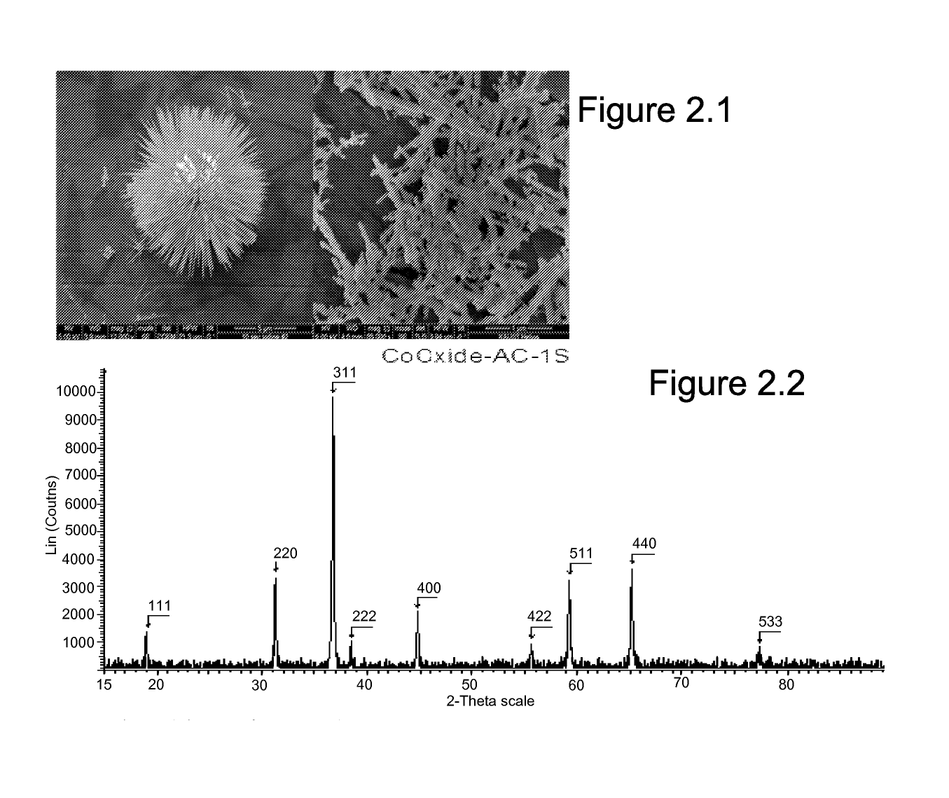

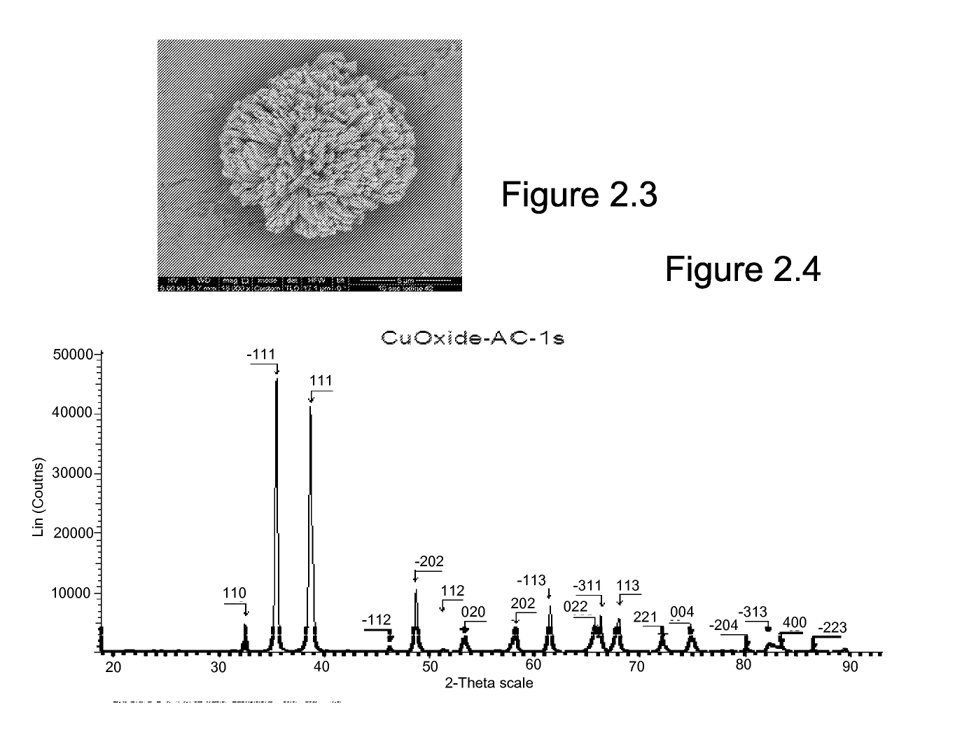

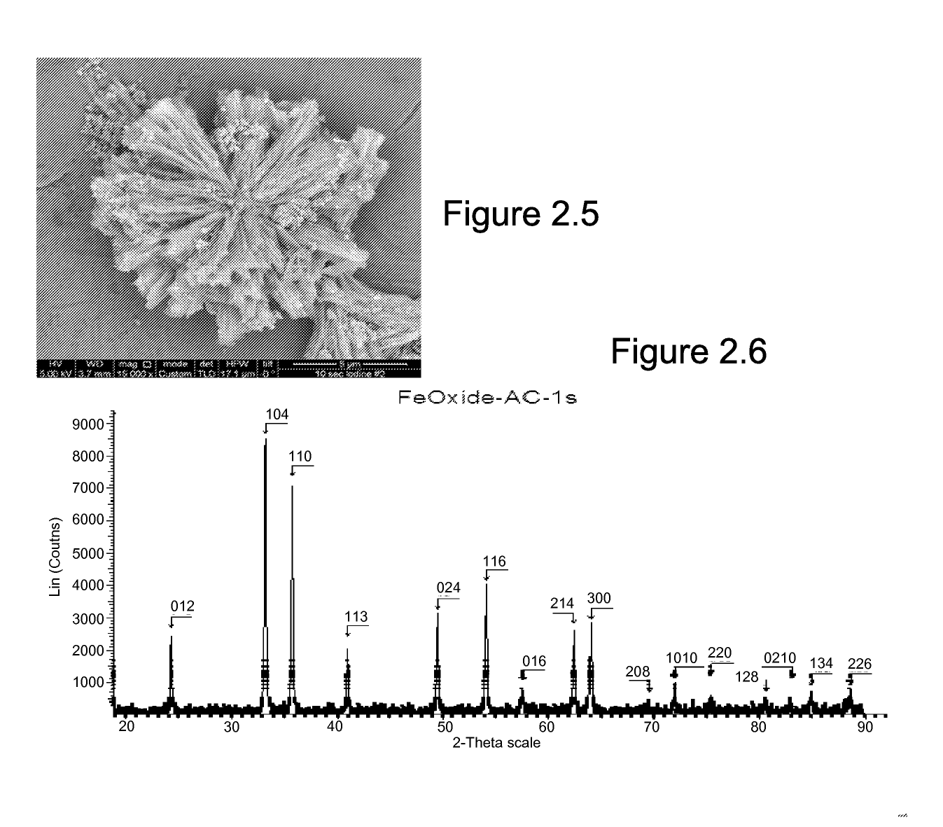

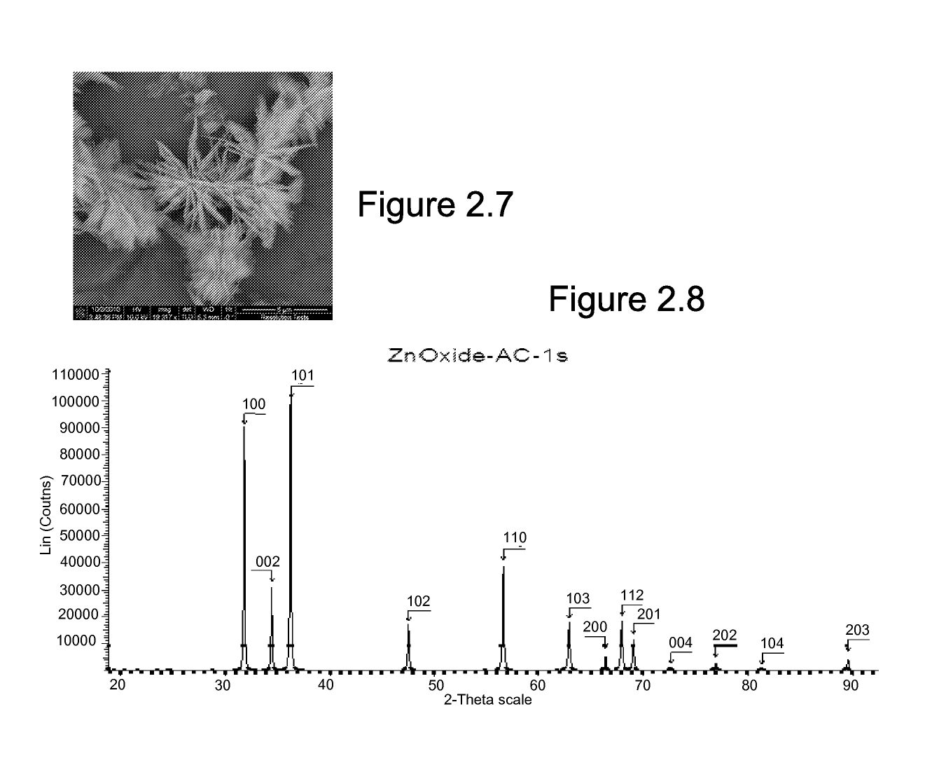

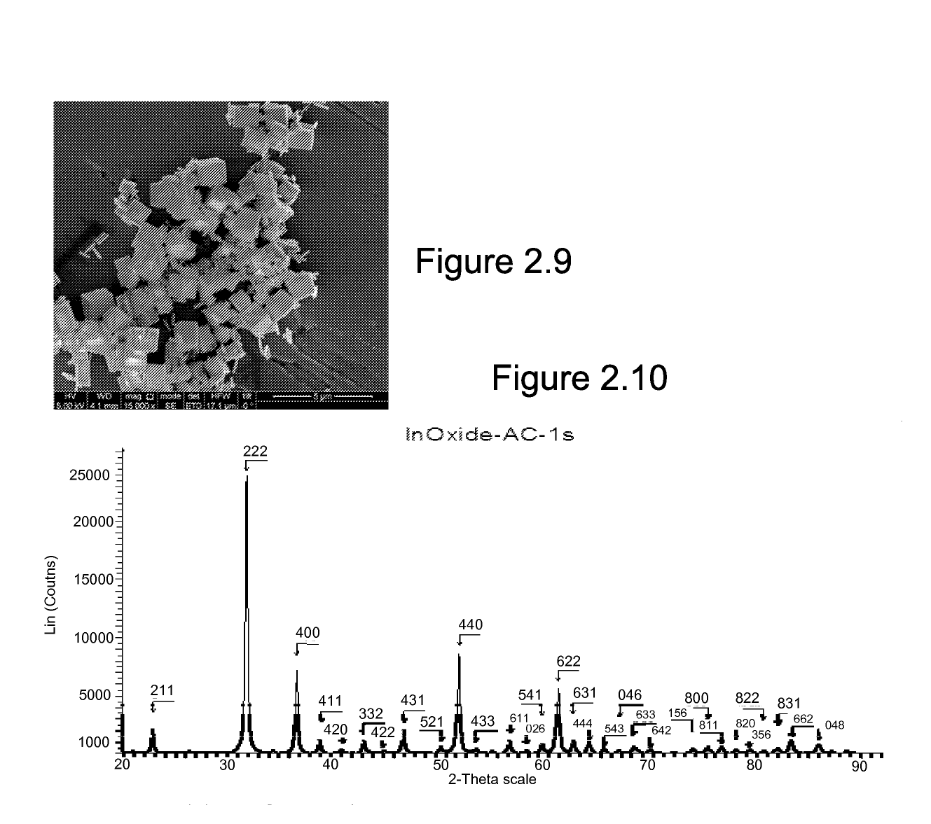

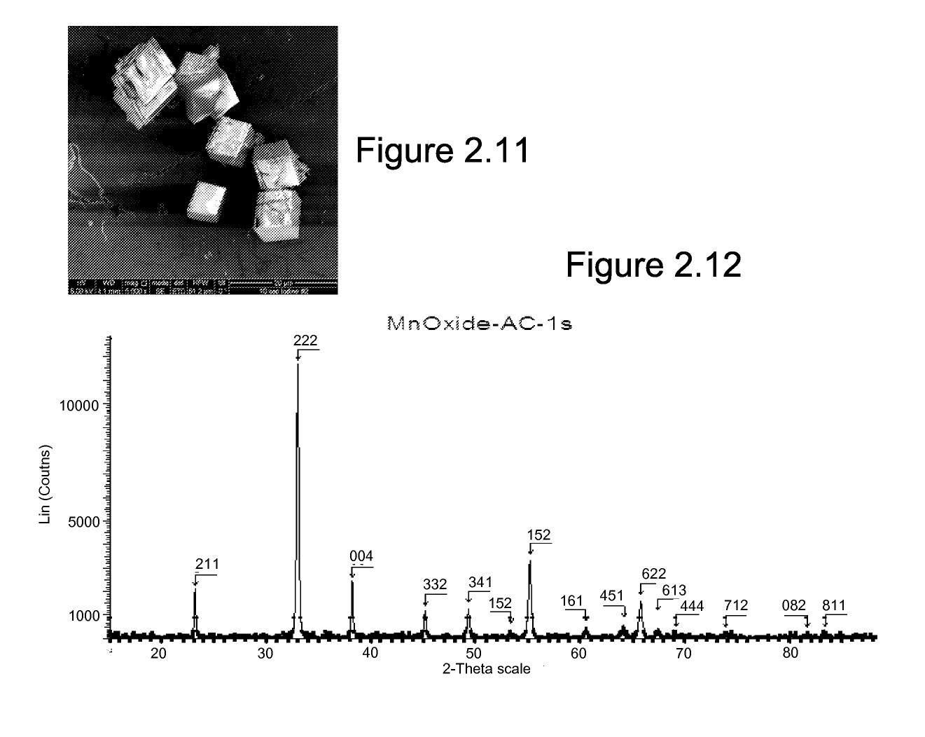

SEM studies revealed the formation of spherical nano-rods with sizes ranging from 200 nm to 500 nm in length (FIG. 2.1). Further structural investigation reveal that these nano-rods are self-assembled in three dimensions (pointed towards the center of sphere and distributed uniformly in all directions) to form flower like structure. Interestingly, when as-synthesized material was calcined at 600 0C for 6 h, we observed de-self assembly of cobalt oxide nano-flowers into nano-rods (FIG. 2.1) and surprisingly closer inspection of the TEM images of this calcined sample reveals that even dissembled nano-rods undergo another de-self assembly (which is very rare phenomenon) to from small spherical particles of cobalt oxides (FIG. 2.1).

X-ray diffraction (XRD) of as-synthesized nanoparticles indicates the formation of cobalt oxide (FIG. 2.2). The peaks could be indexed to the Co₃O₄ phase of cobalt oxide having a face centered structure (JCPDS 01-073-1701). The BET surface area was 44 m²g⁻¹.

MW-assisted hydrothermal heating of cobalt chloride in water-cyclohexane mixture in presence of cetyl pyridinium bromide (CPB) and urea, yielded copper oxides. In a typical synthesis, cetyltrimethylammonium bromide (2 mmol) was dissolved in 40 mL of H₂O and stirred for 20 min. A stirred solution of the precursor copper chloride (1 mmol) in 5 mL of H₂O was then added to the first solution. The mixture was stirred for 1 h at room temperature. The reaction solution was then transferred to a Teflon-sealed microwave reactor. The reaction mixture was exposed to microwave radiation (800 W maximum power) at 120° C. for 4 h. After the mixture was cooled to room temperature, the precipitated powders were isolated by centrifugation; washed thoroughly, in sequence, with distilled water, ethanol and acetone; and air dried. Calcination was performed at 400° C. for 3 h in air.

SEM studies revealed the formation of rectangular nano-rods (FIG. 2.3). Further structural investigation reveal that these nano-rods are also self-assembled in three dimensions (like in case of cobalt oxides) to form flower like structure.

X-ray diffraction (XRD) of as-synthesized nanoparticles indicates the formation of copper oxide (FIG. 2.4). The peaks could be indexed to the CuO phase of copper oxide having a monoclinic structure (JCPDS 01-080-1916). The BET surface area was 6 m²g⁻¹.

Iron oxide was synthesized using hydrothermal technique by simply heating iron chloride in water-cyclohexane mixture in presence of cetyl pyridinium bromide (CPB) and urea under MW irradiation condition. In a typical synthesis, cetyltrimethylammonium bromide (2 mmol) was dissolved in 40 mL of H₂O and stirred for 20 min. A stirred solution of the precursor iron chloride (1 mmol) in 5 mL of H₂O was then added to the first solution. The mixture was stirred for 1 h at room temperature. The reaction solution was then transferred to a Teflon-sealed microwave reactor. The reaction mixture was exposed to microwave radiation (800 W maximum power) at 120° C. for 4 h. After the mixture was cooled to room temperature, the precipitated powders were isolated by centrifugation; washed thoroughly, in sequence, with distilled water, ethanol and acetone; and air dried. Calcination was performed at 400° C. for 3 h in air.

SEM studies revealed the formation of fibrous nano-sheets with (FIG. 2.5). Further structural investigation reveal that these nano-sheets are self-assembled in three dimensions (stacked on each other as well as pointed towards the centre of sphere and distributed uniformly in all directions) to form flower like structure.

X-ray diffraction (XRD) of as-synthesized nanoparticles indicates the formation of iron oxide (FIG. 2.6). The peaks could be indexed to the hematite syn-Fe₂O₃ phase of iron oxide having a rhombo haxes structure (JCPDS 01-071-5088). The BET surface area was 16 m²g⁻¹.

Zinc oxide was also synthesized using hydrothermal technique by simply heating zinc chloride in water-cyclohexane mixture in presence of cetyl pyridinium bromide (CPB) and urea under MW irradiation condition. In a typical synthesis, cetyltrimethylammonium bromide (2 mmol) was dissolved in 40 mL of H₂O and stirred for 20 min. A stirred solution of the precursor zinc chloride (1 mmol) in 5 mL of H₂O was then added to the first solution. The mixture was stirred for 1 h at room temperature. The reaction solution was then transferred to a Teflon-sealed microwave reactor. The reaction mixture was exposed to microwave radiation (800 W maximum power) at 120° C. for 4 h. After the mixture was cooled to room temperature, the precipitated powders were isolated by centrifugation; washed thoroughly, in sequence, with distilled water, ethanol and acetone; and air dried. Calcination was performed at 400° C. for 3 h in air.

SEM studies revealed the formation of nano-sheets (FIG. 2.7). Further structural investigation reveal that these nano-sheets are self-assembled in three dimensions (discreetly organized and pointed towards the center of a circle and distributed uniformly along the periphery of circle) to form star fish like structure.

X-ray diffraction (XRD) of as-synthesized nanoparticles indicates the formation of zinc oxide (FIG. 2.8). The peaks could be indexed to ZnO phase of zinc oxide having a haxagonal structure (JCPDS 01-070-8070). The BET surface area was 41 m²g⁻¹.

MW-assisted hydrothermal heating of indium chloride in water-cyclohexane mixture in presence of cetyl pyridinium bromide (CPB) and urea yielded indium oxide. In a typical synthesis, cetyltrimethylammonium bromide (2 mmol) was dissolved in 40 mL of H₂O and stirred for 20 min. A stirred solution of the precursor indium bromide (1 mmol) in 5 mL of H₂O was then added to the first solution. The mixture was stirred for 1 h at room temperature. The reaction solution was then transferred to a Teflon-sealed microwave reactor. The reaction mixture was exposed to microwave radiation (800 W maximum power) at 120° C. for 4 h. After the mixture was cooled to room temperature, the precipitated powders were isolated by centrifugation; washed thoroughly, in sequence, with distilled water, ethanol and acetone; and air dried. Calcination was performed at 400° C. for 3 h in air.

SEM studies revealed the formation of mixture rectangular nano-rods and cubes (FIG. 2.9). Further structural investigation reveal that these nano-rods undergo Ostwald ripening process and grew into rectangular cubes of indium oxides.

X-ray diffraction (XRD) of as-synthesized nanoparticles indicates the formation of indium oxide (FIG. 2.10). The peaks could be indexed to In₂O₃ phase of indium oxide having a cubic structure (JCPDS 01-071-2194). The BET surface area was 47 m²g⁻¹.

MW-assisted hydrothermal heating of indium chloride in water-cyclohexane mixture in presence of cetyl pyridinium bromide (CPB) and urea yielded indium oxide. In a typical synthesis, cetyltrimethylammonium bromide (2 mmol) was dissolved in 40 mL of H₂O and stirred for 20 min. A stirred solution of the precursor Manganese chloride (1 mmol) in 5 mL of H₂O was then added to the first solution. The mixture was stirred for 1 h at room temperature. The reaction solution was then transferred to a Teflon-sealed microwave reactor. The reaction mixture was exposed to microwave radiation (800 W maximum power) at 120° C. for 4 h. After the mixture was cooled to room temperature, the precipitated powders were isolated by centrifugation; washed thoroughly, in sequence, with distilled water, ethanol and acetone; and air dried. Calcination was performed at 400° C. for 3 h in air.

SEM studies revealed the formation of cubes (FIG. 2.11). Further structural investigation reveals that these cubes were formed by Ostwald ripening of small nanoparticles, as seen in SEM image.

X-ray diffraction (XRD) of as-synthesized nanoparticles indicates the formation of manganese oxide (FIG. 2.12). The peaks could be indexed to Mn₂O₃ phase of manganese oxide having a cubic structure (JCPDS 01-071-0636). The BET surface area was 60 m²g⁻¹.

### Example 3

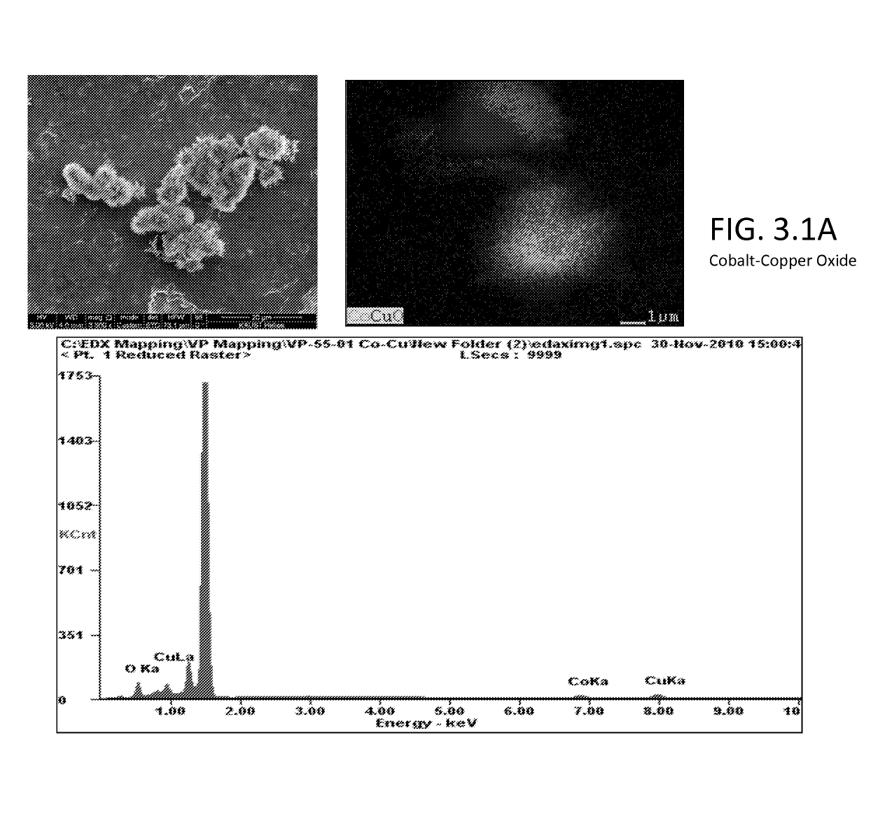

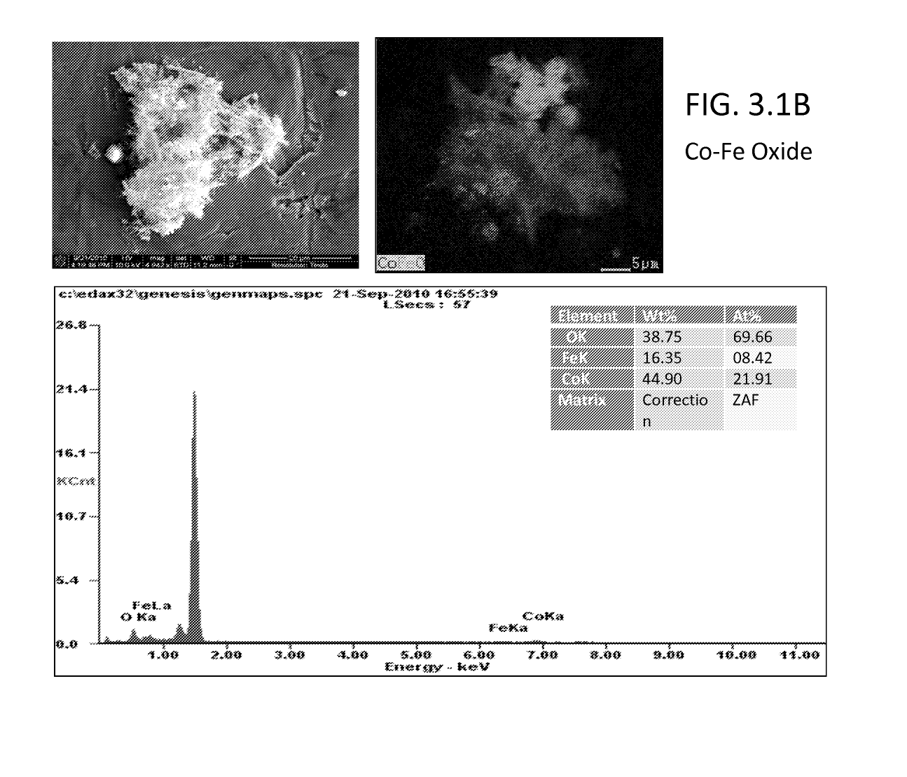

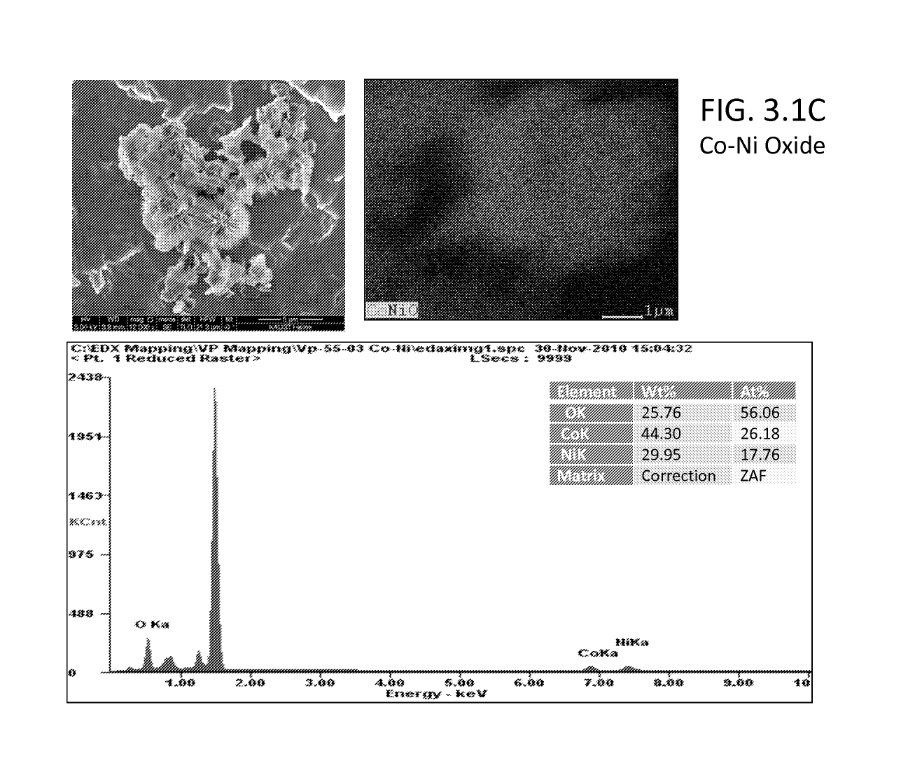

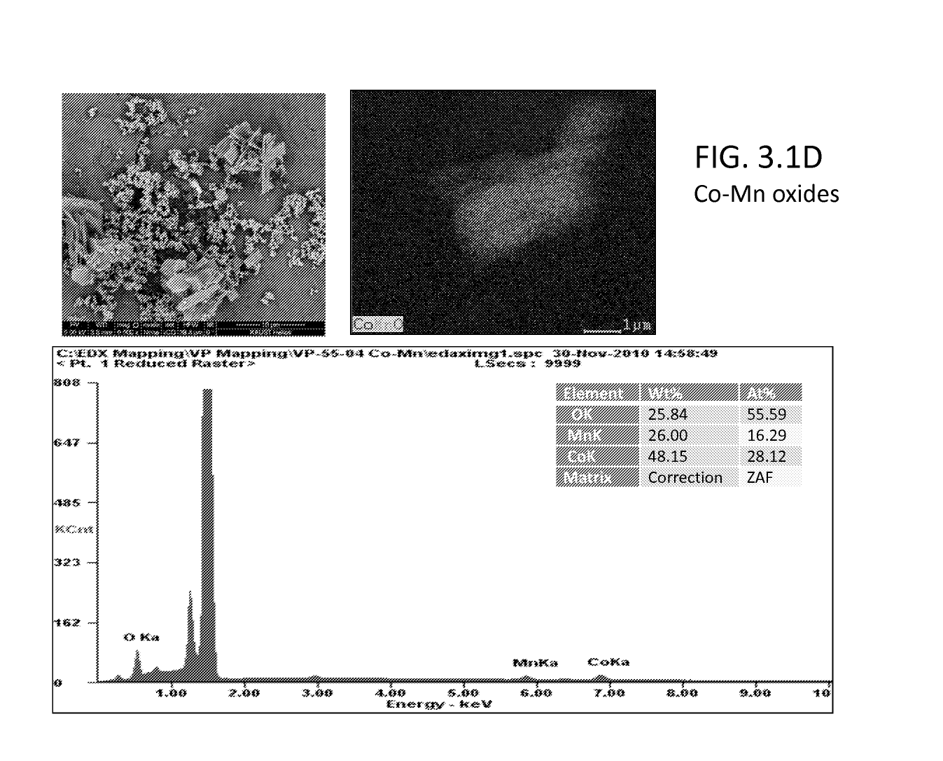

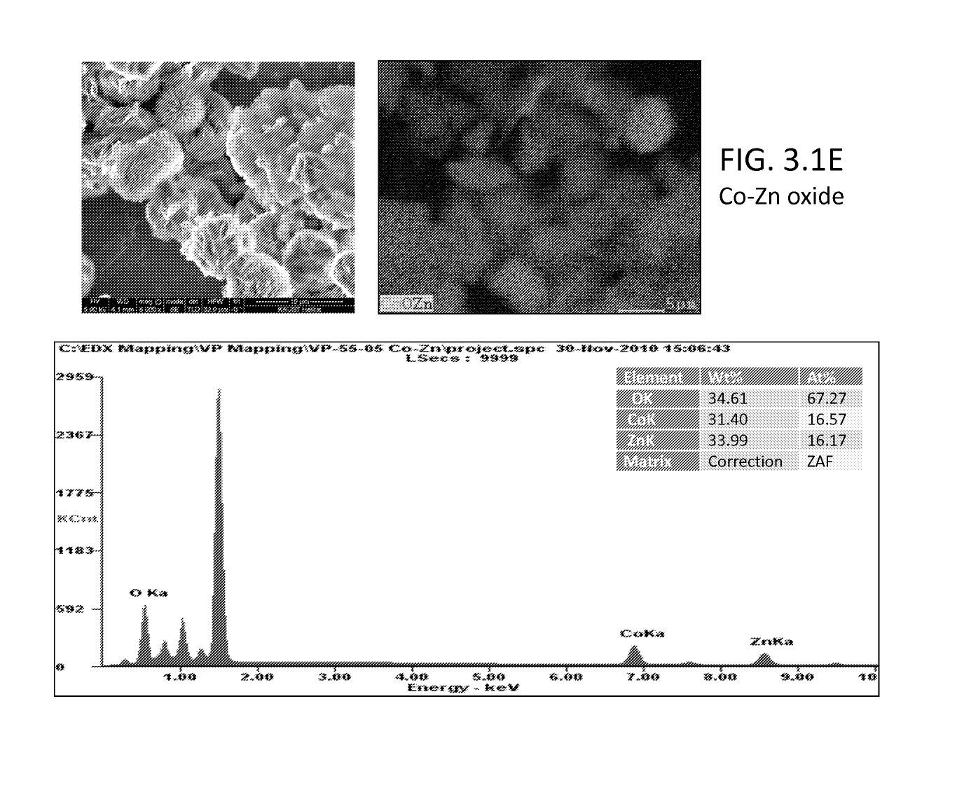

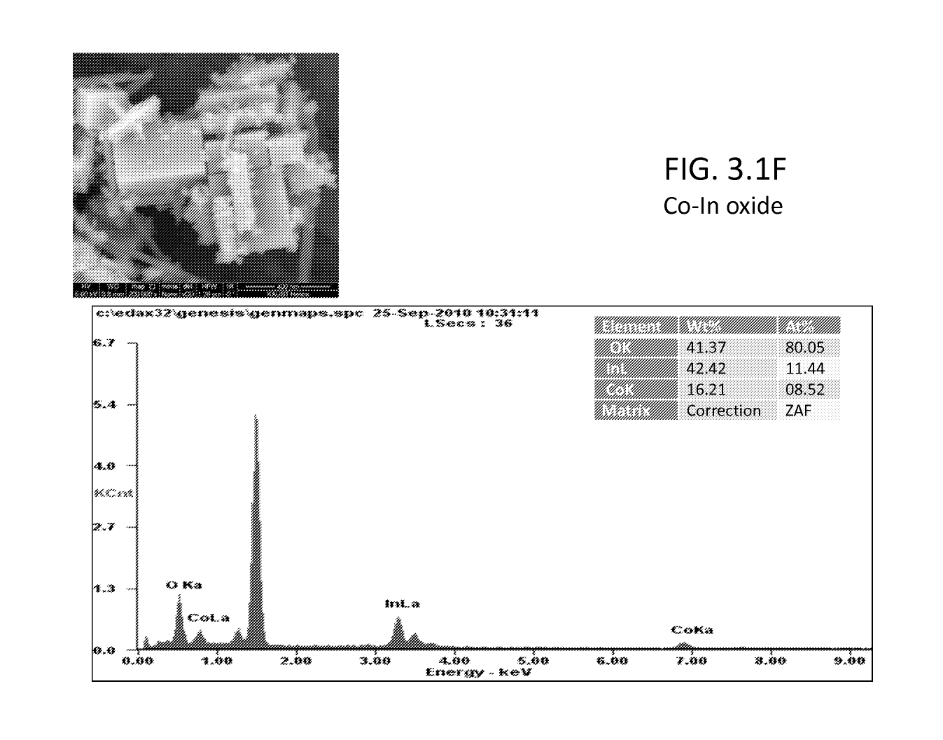

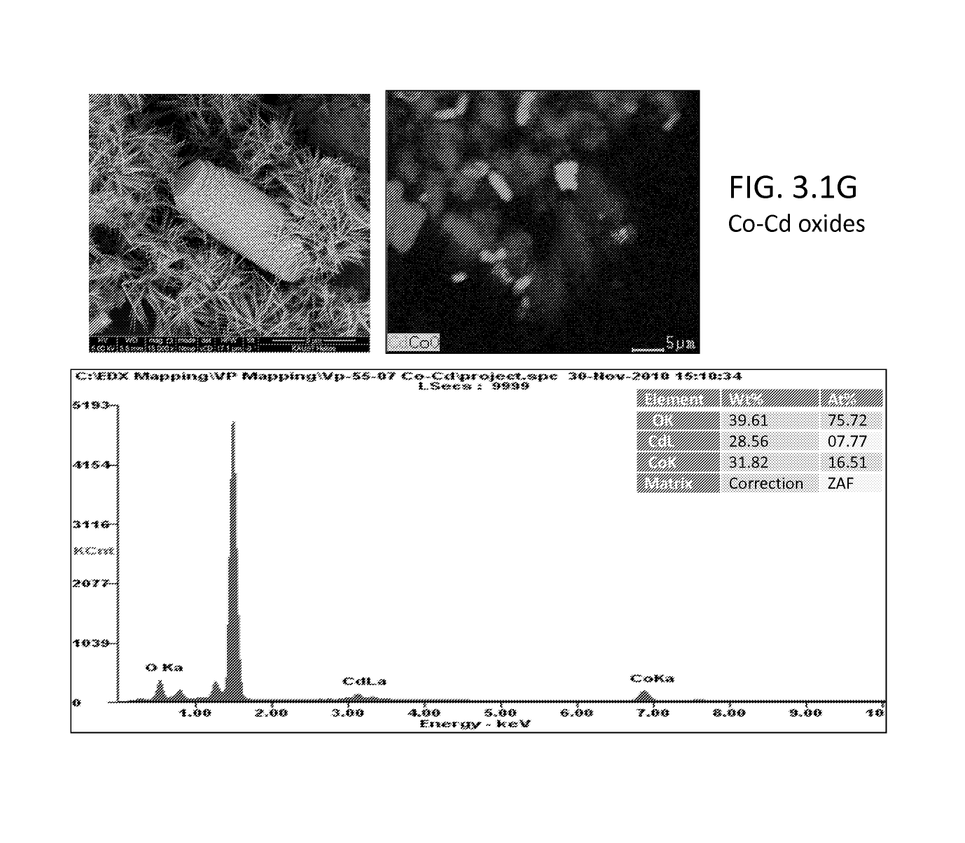

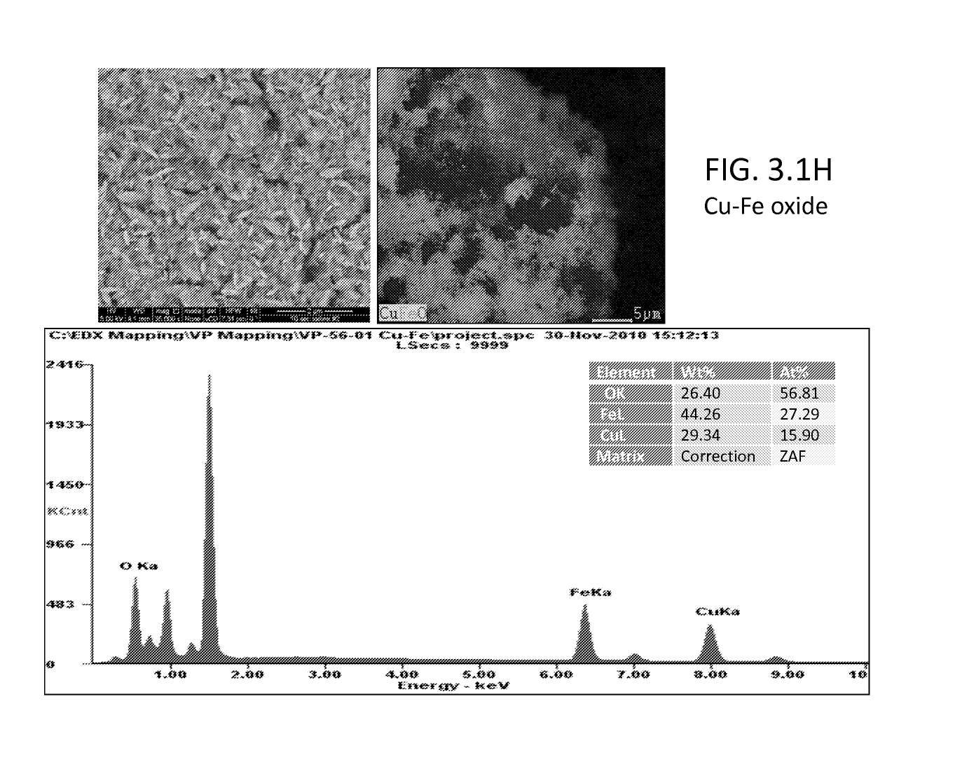

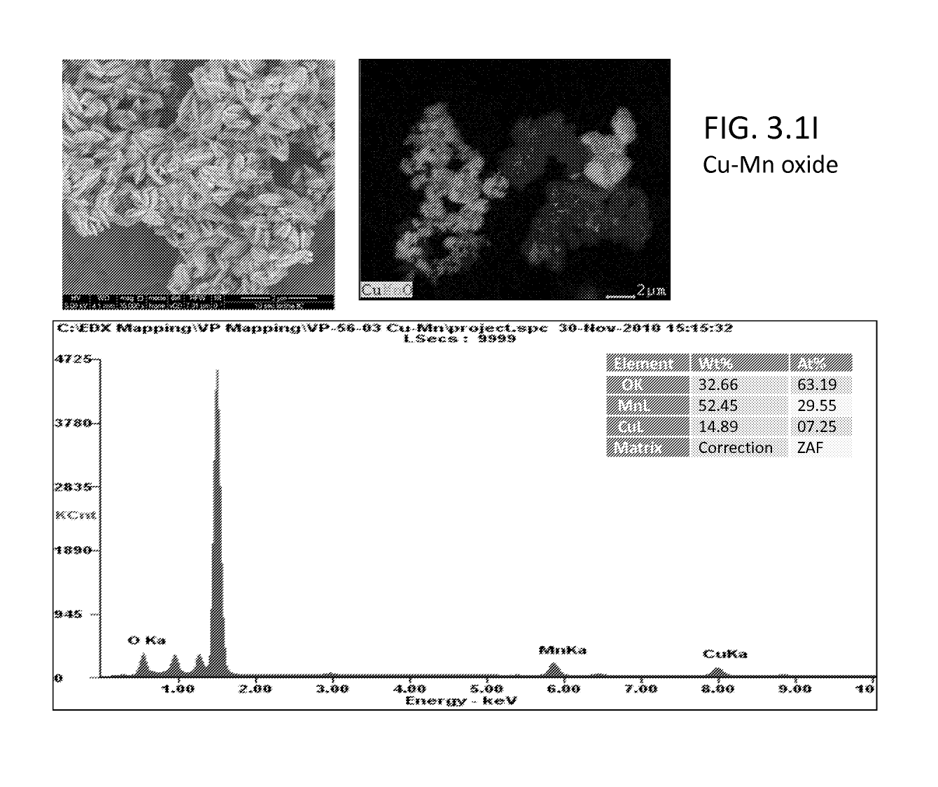

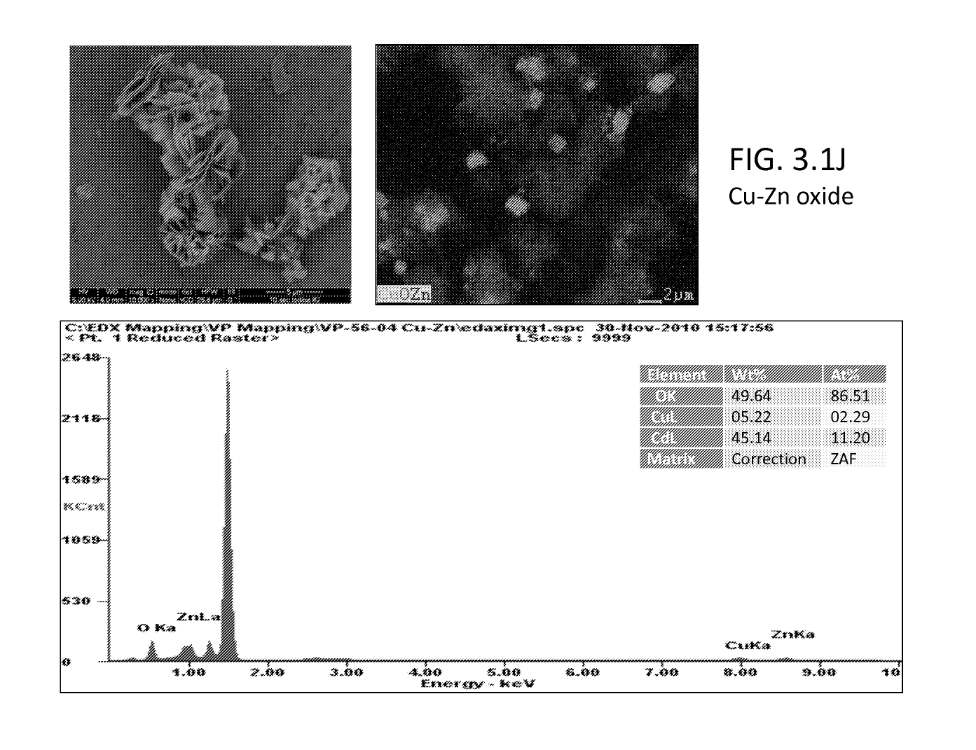

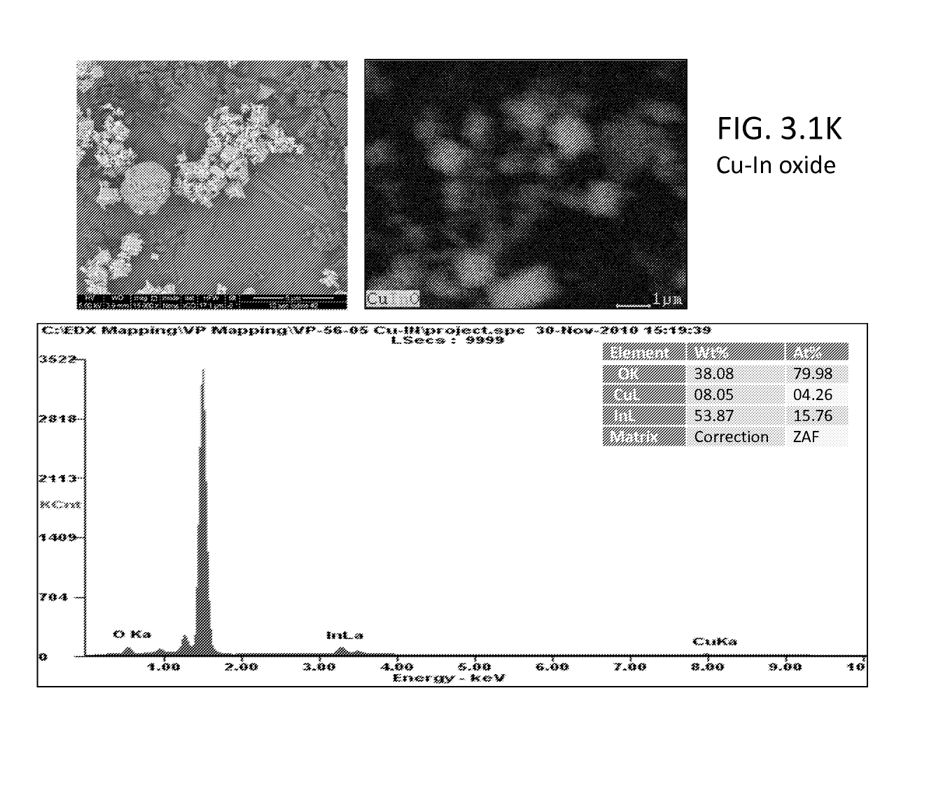

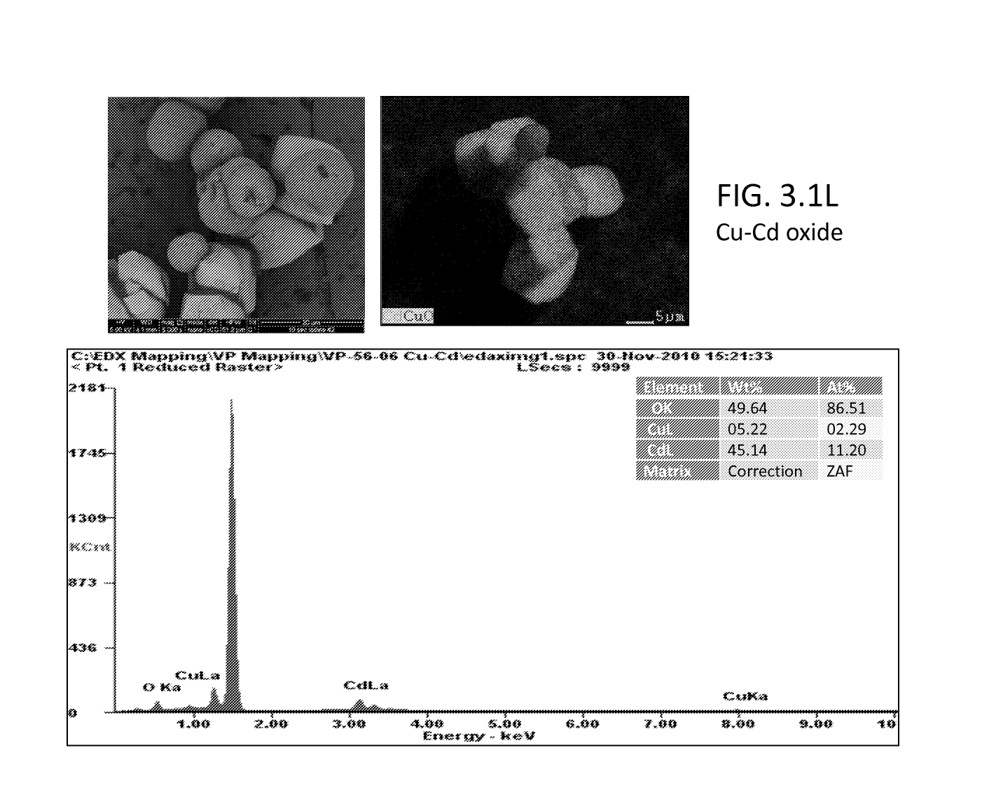

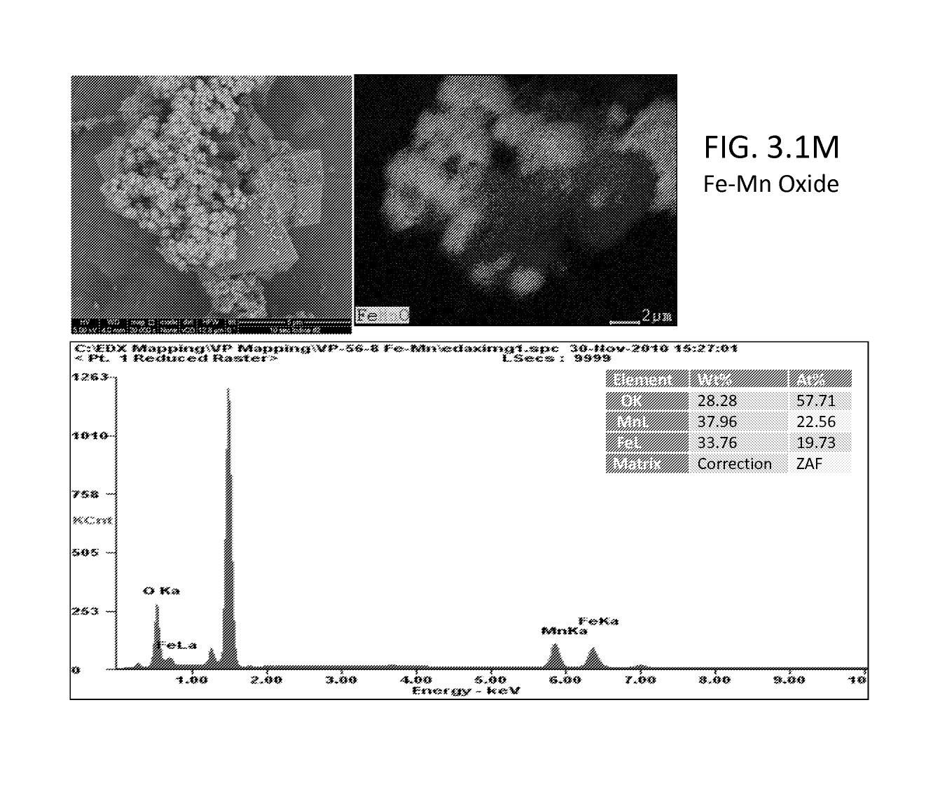

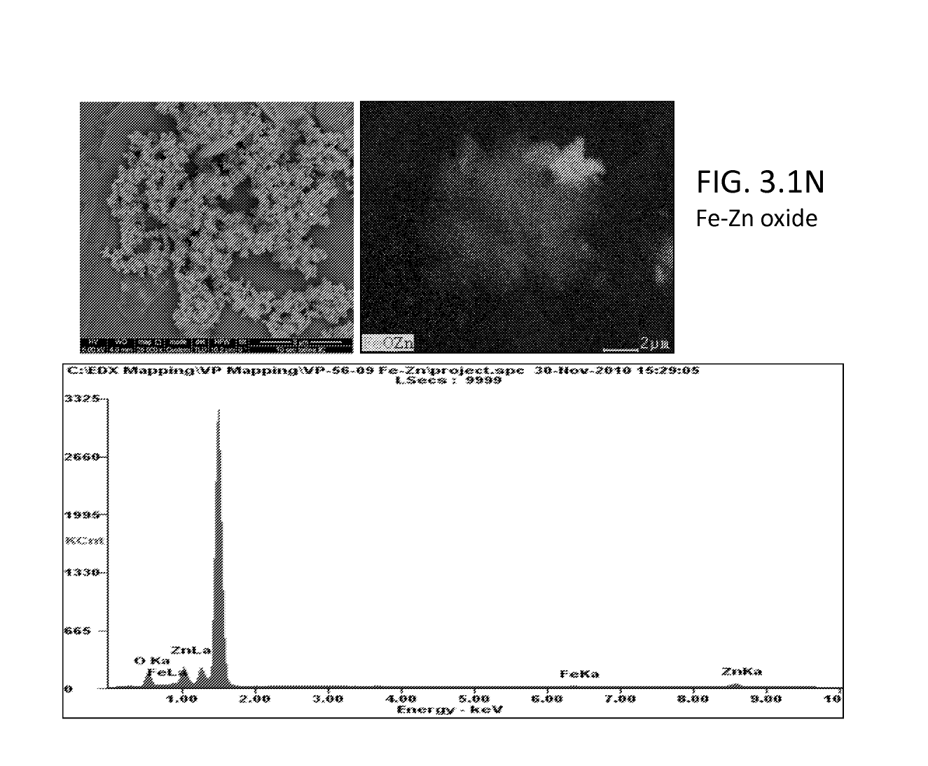

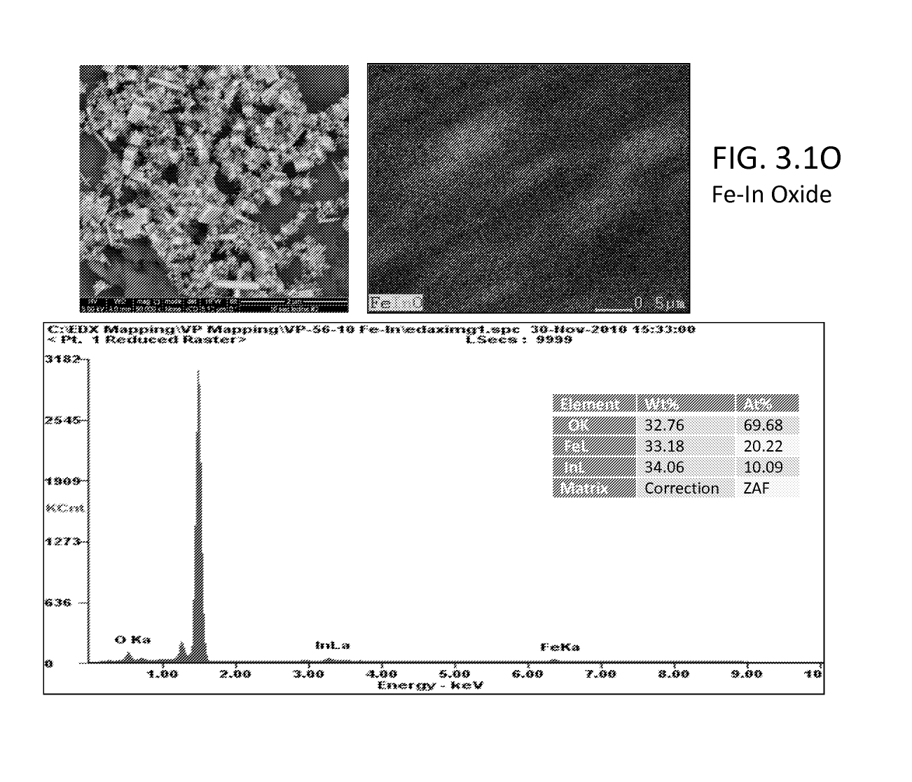

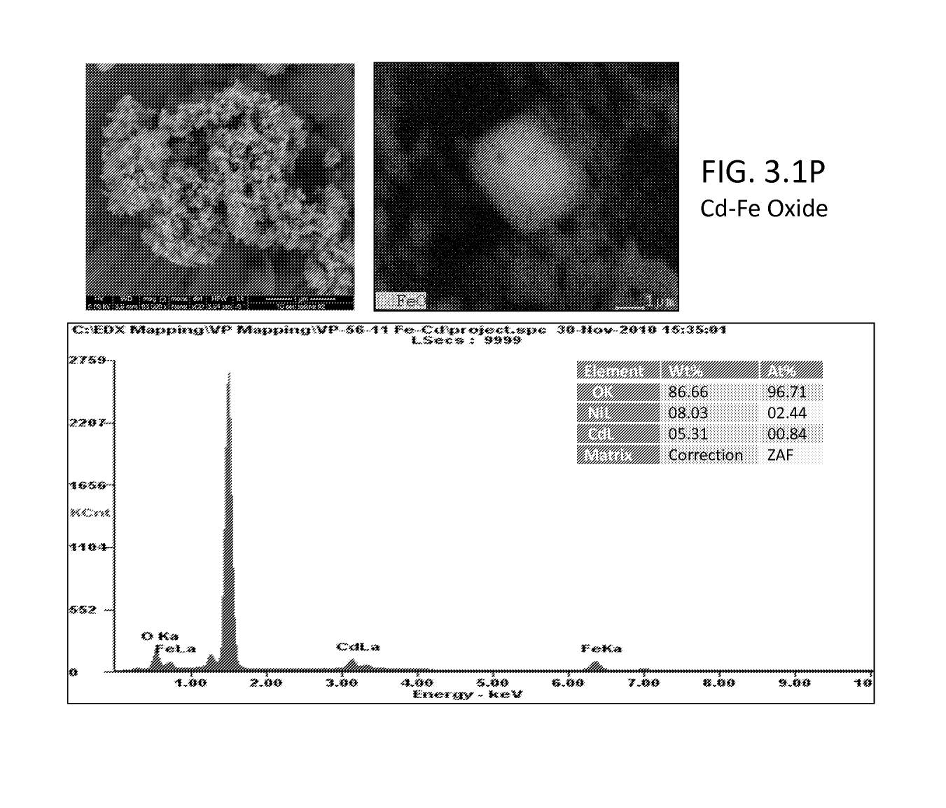

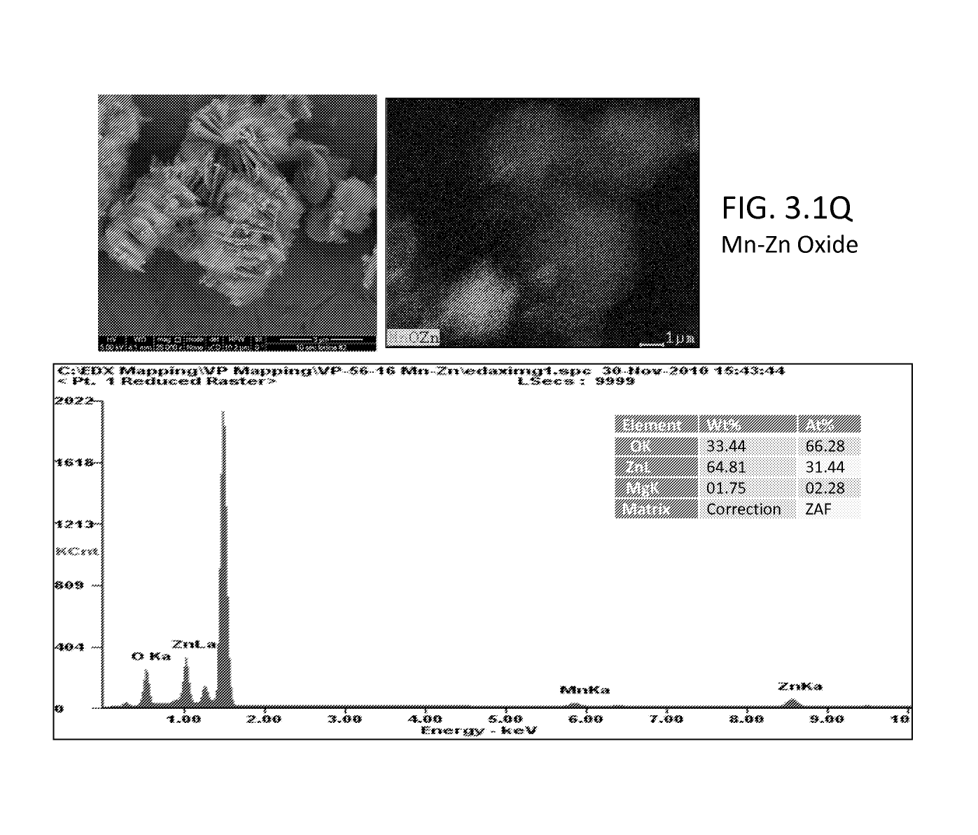

FIGS. 3.1A to 3.1Q illustrate images, EDX mapping, and/or elemental for various nanoparticle oxides.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”. When a range includes “zero” and is modified by “about” (e.g., about one to zero or about zero to one), about zero can include, 0, 0.1. 0.01, or 0.001.

While only a few embodiments of the present disclosure have been shown and described herein, it will become apparent to those skilled in the art that various modifications and changes can be made in the present disclosure without departing from the spirit and scope of the present disclosure. All such modification and changes coming within the scope of the appended claims are intended to be carried out thereby.

We claim at least the following:

1. A method of making a nanoparticle, comprising:
adding a metal compound reagent to water to form a solution;
exposing the solution to a microwave energy; and
forming nanoparticles including the metal of the metal compound.

2. The method of claim 1, further comprising:
removing a precipitate from the solution; and
heating the precipitate to about 200 to 600° C. for about 1 to 3 hours to form nanoparticles.

3. The method of claim 2, wherein the nanoparticle is selected from the group consisting of: cobalt oxide, copper oxide, iron oxide, nickel oxide, cadmium oxide, indium oxide, zinc oxide, manganese oxide, titania, cobalt-copper oxide, cobalt-iron oxide, cobalt-nickel oxide, cobalt-manganese oxide, cobalt-zinc oxide, cobalt-indium oxide, cobalt-cadmium oxide, copper-iron oxide, copper-nickel oxide, copper-manganese oxide, copper-zinc oxide, copper-indium oxide, copper-cadmium oxide, iron-nickel oxide, iron-manganese oxide, iron-zinc oxide, iron-indium oxide, iron-cadmium oxide, nickel-manganese oxide, nickel-zinc oxide, nickel-indium oxide, nickel-cadmium oxide, and manganese-zinc oxide.

4. The method of claim 1, wherein the solution is at a temperature of about 80 to 200° C.

5. The method of claim 1, wherein exposing includes exposing the solution to the microwave energy for about 20 min to 6 hours.

6. The method of claim 1, wherein the solution includes a template compound selected from the group consisting of: cetyltrimethylammonium bromide, cetylpyridinium bromide, a compound represented by the following formula:
CH₃—(CH₂)ₙR₁
wherein n is 5 to 25, and R₁ is 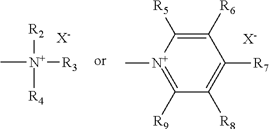
, wherein X⁻ is Cl, Br, I, or F; and R₂ through R₉ are each independently selected from the group consisting of H, Cl, Br, I, OH, and C₁-C₁₀ alkyl; and a combination thereof.

7. A structure, comprising: a nanoparticle made of a material selected from: cobalt oxide, copper oxide, iron oxide, nickel oxide, cadmium oxide, indium oxide, zinc oxide, manganese oxide, titania, cobalt-copper oxide, cobalt-iron oxide, cobalt-nickel oxide, cobalt-manganese oxide, cobalt-zinc oxide, cobalt-indium oxide, cobalt-cadmium oxide, copper-iron oxide, copper-nickel oxide, copper-manganese oxide, copper-zinc oxide, copper-indium oxide, copper-cadmium oxide, iron-nickel oxide, iron-manganese oxide, iron-zinc oxide, iron-indium oxide, iron-cadmium oxide, nickel-manganese oxide, nickel-zinc oxide, nickel-indium oxide, nickel-cadmium oxide, and manganese-zinc oxide.

8. The structure of claim 7, wherein the nanoparticle made of nickel oxide has a morphology like a desert rose and has a BET measured surface area of about 27 m²g⁻¹.

9. The structure of claim 7, wherein the nanoparticle made of cobalt oxide has a morphology like a flower of spherical nanorods and has a BET measured surface area of about 44 m²g⁻¹.

10. The structure of claim 7, wherein the nanoparticle made of copper oxide has a morphology like a flower of rectangular nanorods and has a BET measured surface area of about 6 m²g⁻¹.

11. The structure of claim 7, wherein the nanoparticle made of iron oxide has a morphology like a flower of fibrous nanosheets and has a BET measured surface area of about 16 m²g⁻¹.

12. The structure of claim 7, wherein the nanoparticle made of zinc oxide has a morphology like a flower of fibrous nanosheets and has a BET measured surface area of about 41 m²g⁻¹.

13. The structure of claim 7, wherein the nanoparticle made of indium oxide has a morphology like a rectangular structure and has a BET measured surface area of about 47 m²g⁻¹.

14. The structure of claim 7, wherein the nanoparticle made of manganese oxide has a morphology like a cube and has a BET measured surface area of about 60 m²g⁻¹.

15. The structure of claim 7, wherein the nanoparticle made of nickel-cobalt oxide has a BET measured surface area of about 37 m²g⁻¹.

16. The structure of claim 7, wherein the nanoparticle made of nickel-copper oxide has a BET measured surface area of about 62 m²g⁻¹.

17. The structure of claim 7, wherein the nanoparticle made of nickel-iron oxide has a BET measured surface area of about 56 m²g⁻¹.

18. The structure of claim 7, wherein the nanoparticle made of nickel-manganese oxide has a BET measured surface area of about 28 m²g⁻¹.

19. The structure of claim 7, wherein the nanoparticle made of nickel-zinc oxide has a BET measured surface area of about 86 m²g⁻¹.

20. The structure of claim 7, further comprising one or more ligands attached to it.

21. The structure of claim 20, wherein the one or more ligands are separately selected from the group consisting of: a metal catalytic molecule, a drug, and an organic molecule.

22. The structure of claim 21, wherein a ligand is attached to the nanoparticle via a linker or by absorption or adsorption.

23. The structure of claim 22, wherein the linker is selected from the group consisting of: an alkyl, a hydride, a carbene, a carbyne, a cyclopentadienyl, an alkoxide, an amido, or an imido.

24. The structure of claim 21, wherein the ligand is a metal catalytic molecule.

25. The structure of claim 24, wherein the metal catalytic molecule is a metal ion or a metal oxide

26. The structure of claim 25, wherein the metal catalytic molecule includes a metal selected from the group consisting of: Au, Pt, Pd, Ag, Ni, Ru, Rh, Ir, Os, Co, Fe, and Cu.

27. The structure of claim 25, wherein the metal catalytic molecule is a metal oxide selected from the group consisting of: Al₂O₃, TiO₂, Fe₂O₃, CeO₂, CuO, ZnO, SiO₂, V₂O₅, MgO, La₂O₃, ZrO₂, SnO₂, MnO₂, MoO₃, Mo₂O₅, and a zeolite.

28. A method of delivering a catalyst to a composition, comprising contacting a composition with a nanoparticle as described in claim 7.

29. The method of claim 28, wherein the catalyst is a metal or metal oxide.

30. A method for producing a nanoparticle, comprising the steps of:
a) preparing a composition comprising a metal compound reagent, a template molecule, and a solvent, wherein the template molecule is a compound of formula:
CH₃—(CH₂)ₙ—R₁
wherein n is 5 to 25, and R₁ is 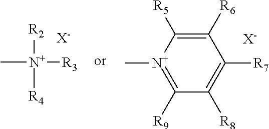
, wherein X⁻ is Cl, Br, I, or F; and R₂ through R₉ are each independently selected from the group consisting of H, Cl, Br, I, OH, and C₁-C₁₀ alkyl;
b) exposing the composition of a) to heat or a microwave irradiation, wherein an oxide-containing particle is formed in the composition; and
c) removing some or all of the solvent from the composition of b) to produce isolated oxide-template particles; and
d) calcinating or refluxing the isolated oxide-template particles of c) to produce oxide nanoparticles.

31. The method of claim 30, wherein the oxide nanoparticle is selected from a metal oxide nanoparticle, a metal-metal oxide nanoparticle, and a combination thereof.

32. The method of claim 30, wherein the template molecule is selected from the group consisting of: cetylpyridinium bromide (CPB), hexadecyltrimethylammonium bromide, and a combination thereof.

33. The method of claim 30, wherein the solvent comprises one or more solvents selected from the group consisting of: cyclohexane, pentanol, and water.

34. The method of claim 30, wherein the composition of a) further comprises urea.

35. The method of claim 30, wherein the composition of a) is exposed to heat and not microwave irradiation.

36. The method of claim 30, wherein the composition of a) is exposed to microwave irradiation and not heat.

37. The method of claim 30, further comprising attaching a ligand to a surface of the nanoparticle.

38. The method of claim 37, wherein the ligand is a metal.

39. The method of claim 38, wherein the metal is selected from the group consisting of: Au, Pt, Pd, Ag, Ni, Ru, Rh, Ir, Os, Co, Fe, Cu, and a combination thereof.

40. The method of claim 37, wherein the ligand is a metal oxide.

41. The method of claim 40, wherein the metal catalytic molecule is a metal oxide selected from the group consisting of: Al₂O₃, TiO₂, Fe₂O₃, CeO₂, CuO, ZnO, SiO₂, V₂O₅, MgO, La₂O₃, ZrO₂, SnO₂, MnO₂, MoO₃, Mo₂O₅, and a zeolite.

42. A method of catalyzing a reaction in a reaction mixture, comprising contacting a reaction mixture with a nanoparticle of claim 7.

43. A kit comprising nanoparticles as set forth in claim 7 in one or more sealed containers.

44. A method for storage of energy, comprising contacting a nanoparticle as set forth claim 7 with a source of energy.

45. The method of claim 44, wherein the source of energy is electricity, heat, or gas.

46. A catalyst material comprising nanoparticles as set forth in claim 7.

47. A method of making a nanoparticle, comprising:
adding a metal compound reagent to water to form a solution;
heating the solution; and
forming nanoparticles including the metal of the metal compound.

48. The method of claim 47, further comprising:
removing a precipitate from the solution; and
heating the precipitate to about 200 to 600° C. for about 1 to 3 hours to form nanoparticles.
